(19) United States
(12) Patent Application Publication
(10) Pub. No.: US 2023/0242463 A1
(43) Pub. Date: Aug. 3, 2023

(54) PROTECTIVE LAYERS AND SELF-CONTAINED HEAT-GENERATING COMPOSITIONS FOR THERMAL GAS GENERATORS

(71) Applicant: Anasphere, Inc., Manhattan, MT (US)

(72) Inventor: John A. Bognar, Belgrade, MT (US)

(21) Appl. No.: 18/160,893

(22) Filed: Jan. 27, 2023

Related U.S. Application Data
(60) Provisional application No. 63/304,177, filed on Jan. 28, 2022.

(51) Int. Cl. C06D 5/06

(52) U.S. Cl. CPC C06D 5/06

(57) ABSTRACT

Gas generating devices and methods of manufacturing and using such gas generating devices are described herein. A gas generator device may be manufactured to include a heat-generating composition that is substantially dimensionally stable during and after a gas generation reaction. The heat-generating composition may comprise one or more binding agents, a structural, physical support, or both. The gas generator device additionally includes a gas generating composition, and in some implementations, may include at least one protective layer. In some embodiments, at least a portion of the at least one protective layer is configured to undergo thermal decomposition or disintegration, using heat generated by a reaction of the heat-generating composition to allow the heat-generating and gas-generating composition to come into contact.

### CROSS-REFERENCE TO RELATED APPLICATION

This application claims the benefit of priority under 35 U.S.C. § 119(e) to U.S. Provisional Patent Application 63/304,177, filed 28 Jan. 2022, the entirety of which is incorporated herein by reference.

### FIELD

This disclosure relates generally thermal gas generator devices, and particularly to thermal gas generator devices that comprise self-contained heat-generating compositions and/or one or more protective layers that prevent physical contact between a heat-generating composition and a gas-generating composition.

### BACKGROUND

In many applications, inflatable articles, i.e., articles that can be inflated with a gas, possess several advantages over rigid structures of the same type. Among these advantages are that an inflatable article can be stored in a small space when not inflated, and that inflatable articles can often achieve the same function as rigid counterparts for a fraction of the mass needed. These advantages are crucial considerations in many embodiments but are particularly important regarding articles or structures adapted for use on aircraft, on spacecraft, in Earth's atmosphere, and in outer space, given that the cost and complexity of launching such articles and structures aboard aircraft or spacecraft can be highly sensitive to the mass and/or volume of the article or structure prior to use.

Finding appropriate devices, methods, and systems to deliver the gas needed to inflate an inflatable structure can often pose various challenges, however. The gas must be generated and delivered to the inflatable article quickly, often in very large quantities; in some aeronautical and astronautical applications, design specifications may call for the production of hundreds of liters of inflation gases in a matter of minutes or even seconds. To accomplish this by conventional means would typically require a housing or tank having substantial mass and volume, which for the reasons previously discussed is often not feasible aboard aircraft or spacecraft and/or in the atmosphere or space. Other applications may require the production of inflation gases in a remote area where it is impractical or impossible to transport tanks or cylinders of gas or to set up conventional gas generators, and in some cases a single person may be required to physically transport the device or system. In all of these applications, as well as others, it is essential to provide compact, lightweight gas delivery devices and systems.

Some gas generator devices may rely on pyrotechnic or heat-generating compositions, such as thermite mixtures, to decompose a gas-generating composition such as a metal hydride and/or a polymer to quickly deliver large volumes of gases. In some gas generator devices, the thermite mixture may be stored in a first compartment and the metal hydride and/or polymer may be stored in a second compartment, where the first compartment and the second compartment may be separated by a separating device. In some gas generator devices, the separating device is a wall (as found in prior hydrogen gas generator designs such as those described in U.S. Patent Application Publication 2021/0422 and U.S. Pat. No. 10,220,930 which are incorporated herein by this reference) or some other permanent separator of a crucible that separates the thermite mixture and the metal hydride and/or polymer, where the wall may comprise steel and/or another heat-resistant material. In such cases, the separator wall can transfer thermal energy generated in the first compartment by reaction of the heat-generating composition to the second compartment, thereby thermally decomposing at least some of the polymer to release a desired gas or mixture of gases. In some gas generator devices, the separating device is a reactive separator or phase-changing separator (as found in prior hydrogen gas generator designs such as those described in co-pending U.S. application Ser. No. 17/390,825, filed Jul. 30, 2021, which is incorporated herein by this reference), i.e., separators that at least partially melt, vaporize, or sublimate due to the heat generated by reaction of the heat-generating composition. In such gas generator devices, the gas-generating composition can be physically separated from the heat-generating composition during manufacture and storage of the device (e.g. to prevent undesired mixing of the two compositions) but allowed to come into direct contact with the heat-generating composition (or slags or reaction products thereof) during and/or after reaction of the heat-generating composition (e.g. to promote complete decomposition of the gas-generating composition, or to accelerate the rate of the reaction)

Previous gas generator devices, however, may suffer from several additional drawbacks. One such drawback is that the separators (whether a permanent wall or a reactive separator) can cause delays in the reaction. With reference to a permanent wall separator, the heat-generating material, e.g., thermite mixture (such as but not limited to a mixture of aluminum metal and iron (III) oxide), can be ignited to produce heat. As heat or thermal energy is produced, the permanent wall may heat and will thus heat the compartment comprising the gas storage medium (e.g., metal hydride, oxalate salt, and/or polymer) which will result in gas production as the gas storage medium decomposes. The rate of the gas generation is thus dependent on how quickly the permanent wall heats. With reference to reactive separator, the separator is in a solid physical state prior to initiation of the reaction in the heat-generating composition but at least a portion thereof becomes a liquid or gas during the reaction. As such, again, the rate of the gas generation is thus dependent on how quickly the reactive separator heats and reacts (i.e., phase changes, melts, disintegrates, etc.) particularly because the reactive wall may be designed to be thick enough to maintain separation of bulk quantities of heat-generating material from bulk quantities of the gas-generating material during transport and storage and thus the reactive wall may require significant time to at least partially decompose. Additionally, upon reaction of the reactive separator, the heat-generating material will no longer be physically separated from the gas-generating mixture which may interfere with the heat-generating reaction itself, or vice versa.

There is thus a need in the art for devices, methods, and systems for generating and delivering a desired gas, or mixture of gases, quickly and from a very small mass and volume. It is further advantageous for such devices, methods, and systems to generate and deliver the gas quickly and in large quantities, while still being suitable for use in challenging environments (the upper atmosphere, space, rugged or remote terrain, etc.). It is still further advantageous for such devices, methods, and systems to enable direct contact between a heat-generating composition and a gas-generating composition during reaction while keeping these compositions separated during manufacture and storage, and to prevent or mitigate premature quenching of the reaction due to reactions of the product gas(es) with oxygen or metal oxides in the generator.

### SUMMARY

These and other needs are addressed by the various embodiments and configurations of the present disclosure.

In an aspect of the present disclosure, a device comprises at least one self-contained article comprising a pyrotechnic composition; and at least one gas generating composition, proximate to a first surface of the self-contained article.

In embodiments, the pyrotechnic composition byproducts may remain substantially in the same location by virtue of their viscosity or solid nature during a gas generation reaction of the at least one gas generating composition.

In embodiments, the at least one self-contained article may further comprise a structure, wherein the structure physically supports the pyrotechnic composition. The structure may, but need not, comprise a supporting mesh. The structure may, but need not, be configured to physically support at least a portion of reaction products of a reaction of the pyrotechnic composition.

In embodiments, the at least one self-contained article may further comprise one or more binding agents.

In embodiments, the device may further comprise at least one protective layer, wherein the at least one protective layer prevents physical contact between the pyrotechnic composition and the at least one gas generating composition. At least a portion of the at least one protective layer may, but need not, be configured to undergo thermal decomposition, using heat generated by a reaction of the pyrotechnic composition. The at least one protective layer may, but need not, be configured such that an unimpeded path exists between at least a portion of the pyrotechnic composition, or reaction products thereof, and at least a portion of the at least one gas generating composition following the thermal decomposition. The at least one protective layer may, but need not, comprise a metal, polymer, paper, or a combination thereof.

In embodiments, the pyrotechnic composition may be a thermite composition comprising a mixture of a metal fuel and a metal oxide oxidizer that undergoes an exothermic reduction-oxidation reaction when ignited by heat.

In embodiments, the at least one gas generating composition may comprise a metal hydride.

In embodiments, the at least one gas generating composition may comprise an oxalate salt.

In embodiments, the at least one gas generating composition may comprise a polymer.

In embodiments, the at least one self-contained article may comprise two or more self-contained articles, or the at least one gas generating composition may comprise two or more gas generating compositions, or both. The at least one self-contained article may, but need not, comprise two or more self-contained articles and the at least one gas generating composition may, but need not, comprise two or more gas generating compositions, and the two or more self-contained articles and the two or more gas generating compositions may, but need not, be disposed in a multi-layer configuration in which successive layers alternate between self-contained articles and gas generating compositions.

In an aspect of the present disclosure, a method for generating at least one gas comprises initiating reaction of a pyrotechnic composition, comprising a metal oxide and a metal and provided as part of a self-contained article, to release thermal energy; and causing, using the thermal energy released by the reaction, at least some of one or more gas generating compositions to undergo a reaction to release the at least one gas.

In embodiments, the pyrotechnic composition byproducts may remain substantially in the same location by virtue of their viscosity or solid nature during the gas generation reaction step.

In embodiments, the self-contained article may further comprise a structure, wherein the structure physically supports the pyrotechnic composition. At least a portion of reaction products of the reaction of the pyrotechnic composition may, but need not, be physically supported by the structure. The structure may, but need not, comprise a mesh.

In embodiments, the self-contained article may further comprise one or more binding agents.

In embodiments, at least one protective layer may prevent physical contact between the pyrotechnic composition and the gas generating composition. The method may, but need not, further comprise causing at least a portion of at least one protective layer to undergo thermal decomposition using the thermal energy released by the reaction of the pyrotechnic composition. The at least one protective layer may, but need not, be configured such that an unimpeded path exists between at least a portion of the pyrotechnic composition, or reaction products thereof, and at least a portion of the gas generating composition following the decomposing step.

In embodiments, the gas generating composition may comprise a metal hydride.

In embodiments, the gas generating composition may comprise an oxalate salt.

In embodiments, the gas generating composition may comprise a polymer.

In an aspect of the present disclosure, an inflatable device comprises an inflatable article; and a gas generator a) interconnected to the inflatable article; b) configured to inflate the inflatable article; and c) comprising i) a thermite composition comprising a metal oxide and a metal; and ii) at least one gas generating composition, wherein the gas generator is configured to generate at least one product gas by (i) initiating a reaction of the thermite composition to release thermal energy and (ii) using the thermal energy released by the reaction of the thermite composition to cause a gas generation reaction of the at least one gas generating composition to generate the at least one product gas, and wherein byproducts of the reaction of the thermite composition remain substantially in the same location by virtue of their viscosity or solid nature during the gas generation reaction of the at least one gas generating composition.

In embodiments, the gas generator may further comprise a self-contained article comprising the thermite composition and one or more binding agents.

In embodiments, the gas generator may further comprise a self-contained article comprising the thermite composition and a structure that physically supports the thermite composition.

In embodiments, the gas generator may further comprise at least one protective layer positioned between and in thermal contact with the thermite composition and the at least one gas generating composition, wherein at least a portion of the at least one protective layer is configured to undergo thermal decomposition using heat generated by the reaction of the thermite composition. The at least one protective layer may, but need not, be configured such that an unimpeded path exists between at least a portion of the thermite composition, or reaction products thereof, and at least a portion of the gas generating composition following the gas generation reaction.

In embodiments, the inflatable device may further comprise an igniter configured to ignite the thermite composition.

The devices and methods of the present disclosure can have several advantages. One possible advantage of the devices and methods of the present disclosure is that they support improved handling, transportation, and storage of the heat-generating and gas-generating components. In one example, devices and methods of the present disclosure support separation of the heat-generating and gas-generating components during transportation, storage, any instance prior to initiation of the reaction, etc. because the heat-generating material is self-contained to a sheet or some other solid form rather than in a bulk, flowable form. As such, it may be easier to prevent the self-contained heat-generating material from contacting the gas-generating material prior to reaction as compared to a bulk, flowable form. Additionally, the heat-generating material in a self-contained form is easier to maneuver and predict which may result in safer handling, transportation, and storage of the heat-generating material.

Another possible advantage of the devices and methods of the present disclosure is that only a thin and/or easily removed protective layer may be needed to keep the heat-generating material and gas-generating material separate prior to reaction because the heat-generating material is self-contained. By eliminating any sort of crucible wall (as found in prior hydrogen gas generator designs such as those described in U.S. Patent Application Publication 2021/0422 and U.S. Pat. No. 10,220,930 which are incorporated herein by this reference) or reactive separator (as found in prior hydrogen gas generator designs such as those described in co-pending U.S. application Ser. No. 17/390,825, filed Jul. 30, 2021 which is incorporated herein by this reference), the hydrogen generator of the present disclosure may run more efficiently. For example, as the protective layer is very thin and/or is easily removable, the protective layer may allow for faster heat transfer between the heat-generating material and the gas-generating material. Additionally, the protective layer will decompose, disintegrate, burn off, melt, etc. faster than other separating layers which may also promote faster heat transfer with relatively low thermal energy requirements to do so.

Another possible advantage of the devices and methods of the present disclosure is that because the heat-generating material is self-contained and only a thin protective layer may be needed to prevent the heat-generating material and gas-generating material separated prior to ignition, the gas-generator device may be lighter (at least as compared to generators with crucible wall separators) which may also promote improved transport, storage, handling, etc. Additionally, gas-generator devices of the present disclosure may be simpler to build.

Another possible advantage, while not wishing to be bound by any theory, is that upon firing, the self-contained heat-generating material may be converted to a cohesive slag (maybe or maybe not supported by an internal structure) or a solid product that cannot physically mix with the metal hydride since it will not flow. In other words, the heat-generating material may remain substantially contained to its original volume throughout the reaction and as such will not physically mix with the gas-generating material. Therefore, the gas-generating mixture will not interfere with the heat-generating reaction itself, and the heat-generating material will not adversely interfere with the gas-generating reaction, such as by quenching the reaction.

Another possible advantage, while not wishing to be bound by any theory, is that upon the thermal decomposition or disintegration of the thin protective layer, a substantially unimpeded path will exist between the heat-generating reaction products and the gas generating material. Such an open path facilitates heat transfer by methods other than direct conduction—for example, by radiative transfer. Such an open path also facilitates better gas flow and mass transport (possibly including unreacted particulate from the gas generating material so that it can directly contact or come into proximity with the heat-generating reaction products).

Another possible advantage of the devices and methods of the present disclosure is that they can generate large quantities of thermal energy, and therefore large quantities of the desired gas or mixture of gases, per unit mass of gas generator. Thus, the devices provided herein can be substantially more compact than conventional devices for generating gases and may therefore allow for the provision of one or more product gases in applications where the significant volume of conventional gas storage solutions (e.g., pressurized cylinders) cannot be accommodated. Additionally, because the heat-generating composition undergoes a reaction that preferably produces little or no offgas—or, in other words, because most of the heat generated by the heat-generating composition is retained in the solid or liquid reaction products—a greater fraction of the thermal energy produced is available to decompose or otherwise cause a reaction of the gas-generating material.

Another possible advantage of the devices and methods of the present disclosure is that they avoid the safety hazards posed by some conventional devices and methods for providing a desired gas. Particularly, pressurized vessels, e.g., gas cylinders, pose various dangers, particularly in challenging environments such as airborne and space environments. In the practice of the present disclosure, none of the reactants (i.e., the heat-generating composition), the gas starting material (i.e., the polymer, metal hydride, and/or oxalate salt), or the reaction product (i.e., the product gas) need ever be pressurized, avoiding the dangers posed by pressurized vessels.

Another possible advantage of the devices and methods of the present disclosure is that the starting materials are resistant to phase change and other unwanted physical and chemical changes prior to reaction of the heat-generating composition. By way of non-limiting example, liquid or gas starting materials may be susceptible to undesirable or even dangerous condensation or freezing when employed in low-temperature environments, e.g., the upper atmosphere and space. By remaining in the solid state and generally nonreactive until ignited, the starting materials used in embodiments of the present disclosure avoid this concern and eliminate the need for costly and/or mass- or volume-intensive liquid or gas storage and handling equipment; in terms of simplicity, long-term storage stability, and cost, storage of solid-state materials is generally far more feasible for many applications than dewars or similar devices for storing liquefied gases.

Another possible advantage of the devices and methods of the present disclosure is that the heat-generating composition may be ignited, and thus the reaction of the gas-generating material to produce the gas(es) of interest, may be ignited by any of several simple and easy methods. Such methods include, but are not limited to, heat, spark, flame, friction, impact, and other pyrotechnic initiation mechanisms.

Another possible advantage of the devices and methods of the present disclosure is that the chemical makeup of the heat-generating composition may be selected or tuned to provide for a desired reaction rate, reaction temperature, amount of thermal energy produced, etc. Particularly, the temperatures at which various widely available polymers decompose are often well-known; as such, the heat-generating composition may be selected (e.g., a particular metal and a metal oxide may be selected as part of a thermite composition for use as a heat-generating composition) to provide an amount of thermal energy sufficient to heat a selected polymer at least to its decomposition temperature. In some embodiments, decomposition or other reaction of the polymer(s), metal hydride(s), and/or oxalate salts may produce two or more product gases in a proportion that is at least partially temperature-dependent, and/or it may be desirable to further heat the product gases to trigger a secondary gas generation reaction; by way of non-limiting example, it may be desirable, in some applications, to cause at least some of an ethylene product gas (resulting, e.g., from the thermal decomposition of polyethylene) to be secondarily decomposed or otherwise reacted to hydrogen gas. As an additional non-limiting example, a higher reaction temperature of the heat-generating composition will in turn increase the amount of thermal energy available to cause reaction of the gas generating material (e.g., polymer, metal hydride, and/or oxalate salt), which in embodiments may cause the gas generating material to react more rapidly and thus limit the formation of undesirable byproducts, impurities, or offgases. In this way, by selecting an appropriate chemical makeup of the heat-generating composition, it is possible for those skilled in the art to control or tune the amount, composition, formation rate, etc. of the product gas(es).

Another possible advantage of the devices and methods of the present disclosure is that they can produce product gases without the use of a catalyst. Specifically, the very high temperatures generated by the heat-generating compositions, e.g., thermite compositions, of the present disclosure can facilitate “brute force” thermal decomposition without the need for a catalyst, and the paths by which the gas generating material decomposes at such temperatures can thermodynamically favor the end product gas(es) rather than any intermediate byproducts or impurities. Of course, it may in some embodiments be desirable to include a catalyst and/or to generate a mixture of two or more product gases; such embodiments are expressly contemplated and within the scope of the present disclosure.

These and other advantages will be apparent from the disclosure of the disclosure contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Polyethylene is a polymer comprising nonpolar, saturated, high molecular weight hydrocarbons. Polyethylenes are divided mainly into two types: (1) low density polyethylene, and (2) high density polyethylene. Polyethylene can also be classified as ultra-high-molecular-weight polyethylene (UHMWPE), ultra-low-molecular-weight polyethylene (ULMWPE), high-molecular-weight polyethylene (HMWPE), high-density cross-linked polyethylene (HDXLPE), cross-linked polyethylene (PEX or XLPE), medium-density polyethylene (MDPE), linear low-density polyethylene (LLDPE), and very-low-density polyethylene (VLDPE).

As used herein, unless otherwise specified, the term “compartment” refers to an area, a layer, a region, or a volume of a gas generator device adjacent to one face, side, or surface of a separator and/or protective layer of the gas generator device. A “compartment” of a gas generator device, as that term is used herein, generally has, or is adapted to have, disposed therein a gas-generating composition (e.g., a metal hydride, polymer, or oxalate salt) or a heat-generating composition (e.g., a thermite mixture). In some embodiments, the gas-generating composition or heat-generating composition may occupy less than the entirety of a compartment (for example, a headspace or air gap may surround the gas-generating composition or heat-generating composition within the compartment), while in other embodiments the gas-generating composition or heat-generating composition may occupy the entirety, or substantially the entirety, of the compartment (for example, the compartment may be a volume lying between one surface of a separator (or protective layer) and a sidewall of the gas generator device, and the gas-generating composition or heat-generating composition may fill, or substantially fill, such volume). It is to be expressly understood that two “compartments” of a gas generator device, as that term is used herein, may, but need not, be completely isolated or sealed from one another; in some embodiments, there may be one or more gaps, passages, spaces, or voids (e.g. about a circumferential edge of the separator or protective layer) that allow gases or other materials to pass from one compartment, adjacent to a first face, side, or surface of a separator or protective layer, to another compartment, adjacent to a second face, side, or surface of the separator or protective layer.

As used herein, unless otherwise specified, the term “thermite” refers to a mixture of a metal fuel and a metal oxide oxidizer. The metal oxide may, but need not, be selected from the group consisting essentially of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both. When ignited by heat, thermite undergoes an exothermic reduction-oxidation (redox) reaction.

In some embodiments, particularly where the desired product gas is or comprises hydrogen gas, the gas-generating composition may comprise one or more metal hydrides. Non-limiting examples of metal hydrides suitable for use in gas generator devices as disclosed herein include lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and mixtures thereof.

In some embodiments, particularly where the desired product gas is or comprises a hydrocarbon such as ethylene, the gas-generating composition may comprise one or more polymers. Non-limiting examples of polymers suitable for use in gas generator devices as disclosed herein include polyethylene, polypropylene, polystyrene, trioxane, and polyoxymethylene.

In some embodiments, particularly where the desired product gas is or comprises a carbon-containing gas such as carbon dioxide, carbon monoxide, or a mixture thereof, the gas-generating composition may comprise one or more oxalate salts. Non-limiting examples of oxalate salts suitable for use in gas generator devices as disclosed herein include tin(II) oxalate (SnC₂O₄), iron(II) oxalate (FeC₂O₄), aluminum oxalate (Al₂(C₂O₄)₃), lithium oxalate (Li₂C₂O₄), sodium oxalate (Na₂C₂O₄), magnesium oxalate (MgC₂O₄), calcium oxalate (CaC₂O₄), ammonium oxalate ((NH₄)₂C₂O₄), other metal oxalates, and combinations and mixtures thereof.

Unless otherwise noted, all component or composition levels are in reference to the active portion of that component or composition and are exclusive of impurities, for example, residual solvents or by-products, which may be present in commercially available sources of such components or compositions.

All percentages and ratios are calculated by total composition weight, unless indicated otherwise.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a device according to some embodiments of the present disclosure;

FIG. 2 depicts a process according to some embodiments of the present disclosure;

FIG. 3 depicts another device for generating a desired gas or mixture of gases according to some embodiments of the present disclosure;

FIG. 4 depicts another process according to some embodiments of the present disclosure;

FIG. 5 depicts another process according to some embodiments of the present disclosure; and

FIGS. 6A and 6B illustrate a device for generating a desired gas or mixture of gases according to some embodiments of the present disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

For purposes of further disclosure and to comply with applicable written description and enablement requirements, the following references generally relate to systems and methods for gas generation and are hereby incorporated by reference in their entireties:
U.S. Pat. No. 3,344,210, entitled “Method of making solid thermite pellets,” issued 26 Sep. 1967 to Silvia (“Silvia”).
U.S. Pat. No. 4,019,932, entitled “Incendiary composition,” issued 26 Apr. 1977 to Schroeder (“Schroeder”).
S. H. Fischer and M. C. Grubelich, “A survey of combustible metals, thermites, and intermetallics for pyrotechnic applications,” paper presented to the 32nd Joint Propulsion Conference and Exhibit of the American Institute of Aeronautics and Astronautics (July 1996) (“Fischer”).
U.S. Pat. No. 10,220,930, entitled “Thermal hydrogen generator using a metal hydride and thermite,” issued 5 Mar. 2019 to Bognar (“the '930 patent”).
U.S. Pat. No. 10,532,800, entitled “Thermal hydrogen generator using a metal hydride and thermite,” issued 14 Jan. 2020 to Bognar (“the '800 patent”).
U.S. patent application Ser. No. 16/741,508, entitled “Thermal hydrogen generator using a metal hydride and thermite,” filed 13 Jan. 2020 by Bognar (“the '508 application”).
U.S. patent application Ser. No. 16/944,132, entitled “Thermal gas generator,” filed 30 Jul. 2020 by Bognar (“the '132 application”).
U.S. patent application Ser. No. 17/390,825, entitled “Phase change separators for thermal gas generators,” filed 30 Jul. 2021 by Bognar (“the '825 application”).

Gas generator devices according to the present disclosure generally utilize a reaction of a heat-generating and/or pyrotechnic composition, often a thermite mixture, to create thermal energy that in turn causes a gas generation reaction of a gas-generating composition, typically a metal hydride, a polymer, and/or an oxalate salt. At least some of the thermal energy created by the reaction of the heat-generating composition may be conveyed or transferred to one or more separators and/or protective layers. Although devices of this general type are known and described, for example, in the '930 patent, the '800 patent, the '508 application, the '132 application, and the '825 application, the gas generator devices of the present disclosure provide an important advantage and benefit in the form of self-contained heat-generating mixtures, i.e., heat-generating mixtures that are at least partially solid or are otherwise non-flowing, with or without a supporting structure, and/or in the form of a protective layer between the heat-generating composition and the gas-generating composition.

In some embodiments of the present disclosure, a heat-generating material may additionally comprise one or more binding agents. The one or more binding agents may be included in the heat-generating material to bind the heat-generating material into a non-free flowing form, i.e., a self-contained form, solid or semi-solid form (i.e., a highly viscous material), etc. The one or more binders may include any number of suitable agents capable of binding the heat-generating material. In some embodiments, the one or more binders may be selected from a group of silicone binders, as described by Schroeder. In some embodiments, the one or more binders may be selected from a group of organic binders. In some embodiments, the one or more binders may be selected from a group of nitrated organic binders, as described by Silvia.

In one embodiment of the present disclosure, the reaction products of the self-contained heat-generating material, and/or any unreacted portion of the self-contained heat-generating material, may retain substantially the same physical shape and/or form after reaction as the self-contained heat-generating material had prior to reaction, as a result of the inherent cohesion of a slag resulting from the heat-generating reaction.

In another embodiment of the present disclosure, the reaction products of the self-contained heat-generating material, and/or any unreacted portion of the self-contained heat-generating material, may retain substantially the same physical shape and/or form after reaction as the self-contained heat-generating material had prior to reaction, as a result of the reaction products being substantially solid, as described by Fischer.

In some implementations, the self-contained heat-generating material may be formed into a particular shape, where the shape may be based on application and use of the gas-generator device, design of the gas-generator device, heat-generating material composition, amount of heat-generating material needed for the gas-generating reaction, gas-generating mixture composition, amount of gas-generating mixture needed for the gas-generating reaction, or a combination thereof. In some non-limiting examples, the self-contained heat-generating material may be formed into a sheet, a block shape (e.g., square or rectangular), a rod shape, a spherical shape, or any other shape. The self-contained heat-generating material may be formed into a solid shape or hollow shape. In some implementations, the self-contained heat-generating material may be formed into a desired shape with or without a support. The particular shape the self-contained heat-generating material is formed into may be based on whether or not a support is used, the type of support used, whether or not binding agents are included in the heat-generating mixture, application and use of the gas-generator device, design of the gas-generator device, heat-generating material composition, amount of heat-generating material needed for the reaction, gas-generating mixture composition, amount of gas-generating mixture needed for the reaction, or a combination thereof.

If a support is used to form the self-contained heat-generating material and in one non-limiting example, the support may be a solid material without gaps (i.e., holes, spaces, non-perforated) or alternatively, may comprise one or more gaps (i.e., perforated, with holes or spaces). In one non-limiting example, the support may be a mesh, or some other interleaved material made of a network of wire, for example. In the example of a mesh-type support, the mesh may have any number of holes, arranged in a uniform pattern or non-uniform pattern, and of any shape and size, etc. The structure may comprise one or more metals (e.g., steel), ceramics, or any other material that will be non-reactive (e.g., chemically and/or physically inert) and/or resistant to reaction with either or both of the heat-generating composition and the gas-generating composition during the gas-generating reaction. Stated another way, the support may comprise one or more suitable materials that will remain substantially chemically and/or physically unchanged throughout the heat-generating and gas-generating reactions.

In some embodiments, the self-contained layer may be formed into a shape (solid or hollow), with a thickness between about 1/32″ (0.8 mm) and about 3/16″ (4.8 mm). Most typically, the thickness is about 1/16″ (1.6 mm). The thickness may be based on the shape the self-contained mixture is formed into, whether or not a support is used, the type of support used, application and use of the gas-generator device, design of the gas-generator device, heat-generating material composition, amount of heat-generating material needed for the reaction, gas-generating mixture composition, amount of gas-generating mixture needed for the reaction, or a combination thereof.

In some implementations, whether one or more binding agents is added to the heat-generating material may be based on whether a support is used to form the self-contained heat-generating material, and vice versa. In one non-limiting example, a binding agent (of a certain type, of a certain quantity) may be added to the heat-generating material when it is desirable to form the self-contained heat-generating material without a support. Alternatively, in another non-limiting example, the one or more binding agents may not be used when a support is used. It is to be expressly understood that one or more binding agents may be included in the heat-generating material when a support is used, or when a support is not used.

In some implementations, the type and/or amount of binder added to the heat-generating material may be based on the shape the self-contained material is formed into, whether or not a support is used, the type of support used, application and use of the gas-generator device, design of the gas-generator device, heat-generating material composition, amount of heat-generating material needed for the reaction, gas-generating mixture composition, amount of gas-generating mixture needed for the reaction, or a combination thereof.

In some embodiments, one or more binding agents may be added to a heat-generating material that result in a self-contained material comprising less than about 2% binding agent, less than about 3% binding agent, less than about 4% binding agent, or less than 5% binding agent. More generally, less than about 10%, even more generally less than about 20%, even more generally less than about 30%, even more generally less than about 40%, even more generally less than about 50%,even more generally less than about 60%, even more generally less than about 70%, even more generally less than about 80%, or yet still even more generally less than about 90% of the self-contained material comprises binding agent.

A self-contained heat-generating material according to the present disclosure addresses drawbacks, or otherwise improves the function, of gas generator devices according to the prior art in several ways. As a first non-limiting example, the self-contained heat-generating material may take advantage of the inherent cohesion of a heat-generating slag, such as a thermite slag, to maintain separation between the thermite composition and/or thermite slag and gas-generating material before, during, and after the heat generating and gas generating reactions. Stated differently, some heat-generating mixtures, such as a thermite mixture, can remain in a solid state, or semi-solid state during and after the heat-generating and gas-generating reactions, rather than melting and flowing. As such, the heat-generating material and the gas-generating material may be prevented from mixing due to the inherent cohesion of the slag at least during the reaction. Therefore, the self-contained material may not negatively interfere with the gas-generating reaction.

In some embodiments, gas generator devices according to the present disclosure may include one single self-contained heat-generating material and one single layer of gas-generating material. Conversely, some embodiments of gas generator devices according to the present disclosure may include more than one self-contained heat-generating material, more than one layer of gas-generating material, or both. Some embodiments may include a “stack” or “sandwich” of multiple self-contained heat-generating material layers and multiple gas-generating material layers, e.g., in which heat-generating material layers and gas-generating materials alternate within the “stack” or “sandwich.” In some of these embodiments, a protective layer may be disposed between each successive heat-generating material layer/gas-generating material layer pair; may be disposed between some, but less than all, successive heat-generating material layer/gas-generating material layer pairs; or may be absent. A “stacked” or “sandwiched” configuration of this type may include one, two, three, four, or any integer more than four layers of self-contained heat-generating material and/or one, two, three, four, or any integer more than four layers of gas-generating material.

Additionally, as the heat-generating material is self-contained, the heat-generating composition and gas-generating composition may be stored, transported, and/or handled in the gas-generator device with improved safety and ease as compared to previous gas generator devices.

A further improvement of the gas generator device due to the heat-generating material being self-contained is that interaction between the heat-generating material mixture and gas-generating mixture may be avoided with ease during transport and storage. In one non-limiting example, one or more protective layers may be placed between the self-contained heat-generating material and the gas-generating mixture in the gas generator device to further prevent the thermite mixture and heat-generating mixture from interacting prior to reaction. Upon ignition, the protective layer may physically change such as by decomposing, melting, evaporating, disintegrating, etc., which may leave the self-contained heat-generating material and gas-generating material to come into contact during the heat-generating and/or gas-generating reaction. A composition of the protective layer may be selected so that the protective layer does not chemically react (i.e., is non-reactive, chemically inert) at least with the heat-generating material and the gas-generating material.

In some embodiments, the protective layer(s) may be at least partially constructed of a metal alloy having a melting, vaporization, disintegration, and/or sublimation temperature lower than the temperature achieved by the reaction of the heat-generating composition. Non-limiting examples of such metals include iron, aluminum, copper, tin, zinc, and alloys and mixtures of those and other metals. In some embodiments, the protective layer may be at least partially constructed of a plastic or polymer composition having a melting, vaporization, and/or sublimation temperature lower than the temperature achieved by the reaction of the heat-generating composition. In some embodiments, the protective layer may be at least partially constructed of a paper-type material (e.g., derived from wood, bamboo, seaweed). In some embodiments, the protective layer(s) may be constructed principally or entirely of such alloys or mixtures, while in other embodiments the protective layer(s) may include a significant fraction or portion of one or more materials that have a melting, vaporization, and/or sublimation temperature higher than the temperature achieved by the reaction of the heat-generating composition, to provide protective layer(s) configured to undergo an incomplete or partial thermal decomposition or disintegration.

In some embodiments, the protective layer(s) may be constructed of multiple layers of two or more different materials. This construction may be particularly advantageous where it is desirable to provide a protective layer that melts, vaporizes, and/or sublimates in a gradual or staged fashion, i.e. where a first layer or portion of the protective layer melts, vaporizes, and/or sublimates at a first temperature and a second layer or portion of the protective layer melts, vaporizes, and/or sublimates at a second, higher temperature during reaction of the heat-generating composition. This construction may also be particularly advantageous where it is desirable to provide a protective layer that undergoes an incomplete or partial thermal decomposition or disintegration, i.e., where a first layer or portion of the protective layer disintegrates due to heat and a second layer or portion of the protective layer does not disintegrate due to heat. The protective layers(s) may comprise one or more paper materials, metals, polymers, or any other suitable material that results in a protective layer with a desired melting point, strength, structural integrity, or a combination thereof. The materials selected to construct the protective layer(s) may be selected from a set of materials compatible (i.e., non-reactive, chemically inert) with the gas-generating composition and heat-generating composition. The materials selected to construct the protective layer(s) may be selected from a set of materials that result in a protective layer with a desired thermal burden required to at least partially remove the protective layer.

In some configurations, the protective layer may be integrated with a more durable physical supporting layer (e.g., a perforated sheet of metal) such that holes in the more durable supporting layer are blocked by the protective layer prior to the heat-generating reaction, and are opened up during the heat-generating reaction as the protective layer disintegrates or thermally decomposes.

In some configurations, the protective layer can be provided as a shaped or molded article comprising voids, wherein at least a portion of the voids are occupied by one or both of 1) a thermite mixture or other heat-generating mixture (such mixture is preferably not gas generating on its own), and 2) a gas-generating composition, such as any one or more polymers, metal hydrides, and/or oxalate salts that can react, e.g., thermally decompose, to produce the desired product gas(es). The gas-generating composition may be in forms such as but not limited to pellets, sheets, tubes, rods, fibers, or custom molded shapes. The heat-generating composition and the gas-generating composition can come into thermal contact with each other by virtue of the melting, vaporization, or sublimation of portions of the shaped or molded article proximate to one or more voids occupied by either or both of the heat-generating composition and the gas-generating composition, thus causing the voids to collapse.

In some embodiments, the protective layer may comprise a thickness no more than about 1/32″ (0.8 mm). More particularly, the protective layer may comprise a thickness no more than about 7/256″ (0.7 mm), or more particularly no more than about 3/128″ (0.6 mm), or more particularly no more than about 5/256″ (0.5 mm), or more particularly no more than about 1/64″ (0.4 mm), or more particularly no more than about 3/256″ (0.3 mm), or more particularly no more than about 1/128″ (0.2 mm), or more particularly no more than about 1/256″ (0.1 mm); the thickness may also be any value lying in a range bounded by any two of the above-mentioned values.

In some embodiments, one or more protective layers may be wrapped or otherwise configured around the self-contained heat-generating material or may be wrapped or otherwise configured around the gas-generating material, or a combination thereof. The one or more protective layers may be attached to a material (i.e., gas-generating and/or heat-generating), such as by a suitable adhesive. In some embodiments, the protective layer(s) may be self-adhesive, such as a polyethylene layer. Alternatively, the one or more protective layers may be self-supporting or may otherwise be configured between the self-contained heat-generating material and the gas-generating material. In some implementations, the protective layers(s) may be arranged in the gas-generator device so that one or both of the heat-generating and gas-generating materials do not interact with (i.e., physical touch) the protective layer(s). Alternatively, the protective layers(s) may be arranged in the gas-generator device so that one or both of the heat-generating and gas-generating materials do contact the protective layer(s). In some embodiments, one or more protective layers may be arranged around the heat-generating material and one or more protective layers may be arranged around the gas-generating material. In some embodiments, a first protective layer may be arranged to entirely surround the heat-generating material, and similarly, a second protective layer may be arranged to entirely surround the gas-generating material. Alternatively, the protective layers may only partially surround the materials, such as in one non-limiting example where a protective layer may be arranged just between the heat-generating material and gas-generating material. As such, other sides of the self-contained heat-generating material, such as a side exposed to the gas-generator device and/or additional free-flowing heat-generating composition may not be covered by a protective layer.

As such, a protective layer according to the present disclosure addresses drawbacks, or otherwise improves the function, of gas generator devices according to the prior art in several ways. In one non-limiting example, because the protective layer is in a solid physical state prior to initiation of the reaction in the heat-generating composition but at least a portion thereof becomes physical changes during the reaction, the gas-generating composition can be physically separated from the heat-generating composition during manufacture and storage of the device (e.g. to prevent undesired mixing of the two compositions) but allowed to come into direct contact with the heat-generating composition (or slags or reaction products thereof) during and/or after reaction of the heat-generating composition (e.g. to promote complete reaction of the gas-generating composition, or to accelerate the rate of the reaction).

Additionally, as compared to the phase-changing separator of the '825 application, the protective layer of the present disclosure acts simply to isolate the self-contained heat-generating material from the gas-generating material prior to reaction, rather than controlling or containing a non-self-contained heat-generating material and gas-generating material. Therefore, the protective layer may be thin and/or lightweight, which may further improve the design, build, handling, etc. of the gas generator device. Additionally, the protective layer may comprise one or more materials with low melting points which may improve the flexibility and/or expense associated with selecting suitable materials to be used for the protective layer.

The heat-generating composition can be a thermite composition, i.e., a mixture of a metal oxide and a metal. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both.

In some embodiments, particularly where the desired product gas is or comprises hydrogen gas, the gas-generating composition may comprise one or more metal hydrides. Non-limiting examples of metal hydrides suitable for use in gas generator devices as disclosed herein include lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and mixtures thereof.

In some embodiments, particularly where the desired product gas is or comprises a hydrocarbon such as ethylene, the gas-generating composition may comprise one or more polymers. Non-limiting examples of polymers suitable for use in gas generator devices as disclosed herein include polyethylene, polypropylene, polystyrene, trioxane, and polyoxymethylene.

In some embodiments, particularly where the desired product gas is or comprises a carbon-containing gas such as carbon dioxide, carbon monoxide, or a mixture thereof, the gas-generating composition may comprise one or more oxalate salts. Non-limiting examples of oxalate salts suitable for use in gas generator devices as disclosed herein include tin(II) oxalate (SnC₂O₄), iron(II) oxalate (FeC₂O₄), aluminum oxalate (Al₂(C₂O₄)₃), lithium oxalate (Li₂C₂O₄), sodium oxalate (Na₂C₂O₄), magnesium oxalate (MgC₂O₄), calcium oxalate (CaC₂O₄), ammonium oxalate ((NH₄)₂C₂O₄), other metal oxalates, and combinations and mixtures thereof.

To start the generator, the heat-generating material, e.g., thermite mixture (such as but not limited to a mixture of aluminum metal, iron (III) oxide, and/or chromium (III) oxide), can be ignited to produce heat. As heat or thermal energy is conducted from the heat-generating composition to the gas-generating composition, a mixture of gases (e.g., including, in the case of polyethylene, a substantial portion of ethylene) is initially produced as the gas-generating composition reacts. This gas mixture may be used as-is, thermally and/or catalytically treated to yield a more desirable gas mixture, and/or have undesirable components removed through means such as but not limited to filters, sieves, traps, or condensers.

Various embodiments of the gas generator device will now be discussed with reference to the figures.

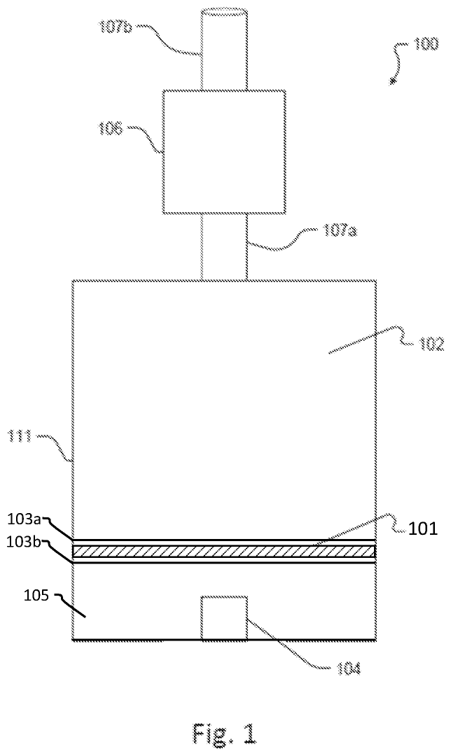

FIG. 1 depicts a non-limiting configuration of a gas generator device 100. The gas generator device 100 comprises a self-contained material 101 (comprising a heat-generating composition) and a compartment 102 containing a polymer, metal hydride, and/or oxalate salt (a “gas-generating composition”). The self-contained material 101 and compartment 102 are typically separated from an outside environment by a wall 111. In some implementations, the self-contained material 101 and compartment 102 are separated from each other by one or more protective layers 103, such as protective layer 103a. It is to be expressly understood that the self-contained material 101 and compartment 102, may, but need not, be completely isolated or sealed from one another; in some embodiments, there may be one or more gaps, passages, spaces, or voids (e.g. about a circumferential edge of the protective layer 103) that allow gases or other materials to pass from the self-contained material 101, adjacent to a first face, side, or surface of the protective layer 103, to the compartment 102, adjacent to a second face, side, or surface of the protective layer 103. The protective layer 103 is in thermal contact with the self-contained material 101 and compartment 102. Thermal energy generated by the self-contained material 101 by reaction of the heat-generating composition is transferred to the compartment 102 by or upon removal of the protective layer 103, whereby at least some of the thermal energy transferred to the compartment 102 causes at least some of the gas-generating composition to react (e.g., thermally decompose) to release at least one product gas.

Described another way, gas generator device 100 comprises a single or common compartment containing both the heat-generating composition and the gas-generating composition, where the common compartment is typically separated from an outside environment by a wall 111. The common compartment may be divided into sections at least by a self-contained material 101, such as into section 102 comprising the gas-generating composition and section 105 which may or may not comprise additional heat-generating composition, such as free-flowing heat-generating composition.

Gas generator device 100 may be configured with one or more self-contained heat-generating materials 101, such as a self-contained heating generating material 101 described herein. The self-contained material 101 may comprise a thermite mixture and in some embodiments, may additionally comprise one or more binding agents. In some implementations, the heat-generation composition of the self-contained material 101 may be supported by one or more internal, physical structures to promote the self-contained nature of the material. The self-contained material 101 may be configured into a non-free flowing form, i.e., a self-contained form, solid form, etc. and may remain substantially in the self-contained form throughout the heat-generating and gas-generating reactions.

In some embodiments, the self-contained heating generating material 101 may comprise the entirety of the thermite needed to carry out the heat-generating and gas-generating reactions. In such embodiments, the self-contained material 101 may eliminate the need for bulk, free-flowing thermite in the device 100. In some embodiments, in addition to the self-contained heating generating material 101, the device 100 may additionally include bulk, free-flowing thermite in the device 100. The bulk, free-flowing thermite may be included in compartment 105, or any other suitable location within device 100.

The self-contained material 101 comprises a first volume, the compartment 102 has a second volume, and compartment 105 may comprise a third volume. The gas generator device 100 has a device volume. In some configurations the device volume can be the sum of the first 101, second 102, and/or third 105 volumes. In some configurations, the device volume can be more than the sum of the first 101, second 102, and third 105 volumes. The walls 111 that separate one or both of 101, 102, and 105 from a surrounding environment and may comprise, separately and independently, one or more of steel, aluminum, and ceramic.

Most typically, the heat-generating composition comprises a thermite composition, which in turn comprises a metal (i.e., a fuel) and a metal oxide (i.e., an oxidizer). The thermite reaction, i.e., the exothermic reduction-oxidation reaction between a metal fuel and a metal oxide when ignited by heat, has been known for well over a century; see, e.g., U.S. Pat. No. 906,009, entitled “Manufacture of thermic mixtures,” issued 8 Dec. 1908 to Goldschmidt (“Goldschmidt”), the entirety of which is incorporated herein by reference. The thermite reaction is generally non-explosive but can create intense heat and high temperatures; it thus finds a variety of useful applications, (e.g., welding, metal refining, disabling munitions, incendiary weapons, and pyrotechnic initiators) and so is widely, and (for many formulations) inexpensively, available from many suppliers. The metal oxide may, but need not, be selected from the group consisting essentially of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both.

In one configuration, the heat-generating composition comprises a thermite composition that comprises a mixture of ferric oxide and aluminum. The chemical reaction of this thermite mixture is shown below in chemical equation (1):

Fe₂O₃(s)+2 Al(s)→2 Fe(s)+Al₂O₃(s) (1)

The thermite chemical reaction is exothermic and releases a large quantity of thermal energy, resulting in temperatures sufficient to produce an aluminum oxide slag and molten iron. The enthalpy or heat of reaction (ΔH° value) for the thermite reaction is about −849 kJ (e.g., −849 kJ per mole Fe₂O₃). The thermite reaction does not require external oxygen and can, therefore, proceed in locations with limited or no air flow (e.g., in space), or even under water. Furthermore, the reaction of many types and mixtures of thermite does not produce any gases which might carry away some of the heat of the reaction or produce an explosive excess of pressure.

It can be appreciated that the heat-generating composition can generate very large amounts of thermal energy per unit mass of the heat-generating composition. A compact gas generating system can thus be achieved by producing such large amounts of thermal energy per unit mass of the heat-generating composition. Furthermore, in many embodiments, substantially most of the heat generated remains available to cause reaction, e.g., thermal decomposition, of the gas-generating composition because gaseous byproducts are not produced; that is, most of the heat is retained in the liquid and/or solid reaction products as a source of thermal energy.

Typically, at least some of the thermal energy transferred to the compartment 102 by the heat-generating material (i.e., self-contained material 101) causes some of the gas-generating composition contained in the compartment 102 to undergo a gas generation reaction; in some embodiments, the gas generation reaction may be a thermal decomposition reaction. The gas generation reaction of the gas-generating composition releases one or more product gases. By way of non-limiting example, polyethylene can be thermally decomposed to ethylene gas, and in some embodiments at least a portion of the ethylene gas may be secondarily decomposed (either thermally or catalytically) to hydrogen gas.

In some embodiments, at least about 99 mole % of the gas-generating composition may be converted to the one or more product gases. More generally, at least 95 mole %, even more generally at least about 90 mole %, yet even more generally at least about 80 mole %, still yet even more generally at least about 70 mole %, still yet even more generally at least about 60 mole %, still yet even more generally at least about 50 mole %, still yet even more generally at least about 40 mole %, still yet even more generally at least about 30 mole %, still yet even more generally at least about 20 mole %, or yet still even more generally at least about 10 mole % of the gas-generating composition may be converted to the one or more product gases.

It can be appreciated that, in many embodiments, there is no need to control one or both of the temperature and the rate of thermal energy transfer within the device 100. As a result, the device 100 can be configured to transfer thermal energy rapidly between the self-contained material 101 and compartment 102, thereby causing reaction, e.g., thermal decomposition, of the gas-generating composition to release the one or more product gases more rapidly than current gas generation systems. Moreover, the device 100 can be more easily constructed and operated than other gas generators; for example, there is not always a need to have the gas generation reaction occur at any specific temperature, so neither the reaction of the heat-generating composition nor the transfer of thermal energy from the self-contained material 101 to the compartment 102 must necessarily be regulated. This contrasts with catalytic decomposition methods, which require the catalyst to be operated at specific temperatures, pressures, and reactant flow rates. Even more advantageously, in those embodiments where control over one or both of the temperature or the rate of energy transfer within the device 100 is required or desired, such control can be achieved by varying the chemical makeup of the thermite or other heat-generating composition within the self-contained material 101, without the need to rebuild or retrofit the device 100 itself.

The gas generator device 100 may further include an igniter 104, which may be interconnected with the self-contained material 101. The igniter 104 causes the ignition of the heat-generating composition. In some configurations, a spark generated within the igniter 104 initiates the ignition process. In other configurations, the ignition process is initiated by thermal energy generated within the igniter 104. The thermal energy provided within igniter 104 may be from a hot wire. In other configurations, the initiating energy within igniter 104 may be from flame. In other configurations, the initiating energy within the igniter 104 may be provided by friction and/or impact.

The igniter 104 may further comprise an ignition aperture proximate to the self-contained material 101. The ignition aperture may be configured with a safety-delay switch system.

The gas generator device 100 may further include a heat exchanger 106 interconnected with the compartment 102. The heat exchanger 106 is configured to cool the product gas(es) released from the gas-generating composition. In accordance with some embodiments, the heat exchanger 106 may be interconnected to outlet 107a of the compartment 102. The exchanger 106 cools the product gas(es) exiting the second compartment 102 through outlet 107a and releases the cooled gas through outlet 107b.

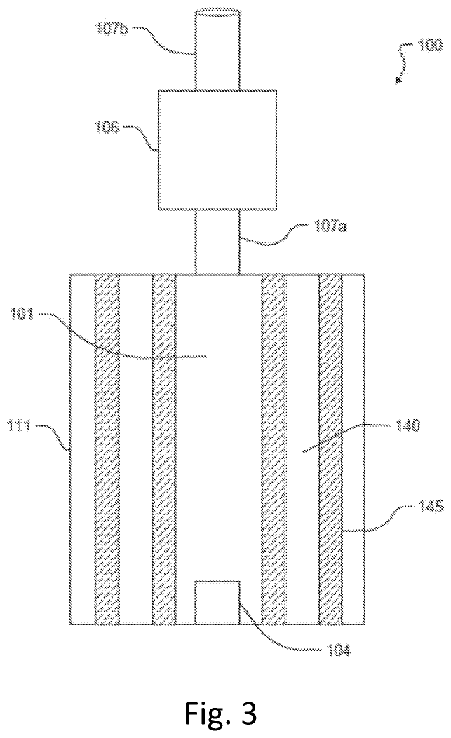

It is to be expressly understood that that the self-contained material 101, protective layer(s) 103, and compartment 102 can be spatially arranged in any suitable configuration. By way of non-limiting example, in some embodiments, the self-contained material 101 may be arranged perpendicular to the plane of the ignitor 104, as depicted, and/or, may be arranged parallel to the plane of the ignitor 104, not depicted. In some implementations, the self-contained material 101 may be arranged in a straight line from one wall 111 to another wall 111 of the device 100, as depicted. In some implementations, the self-contained material 101 may be arranged to surround each side of the ignitor 104. In some embodiments, the device 100 may be configured to comprise multiple self-contained materials 101, as described in more detail with reference to FIG. 3. One or more self-contained materials 101 may be arranged to form any suitable shape, shape, curve, geometry, etc. and may be placed in any suitable orientation within the walls 111 of the device 100.

By way of a non-limiting example, in some embodiments, the device 100 may comprise one or more protective layers 103, such as protective layers 103a and 103b. In some implementations, protective layer 103b between the self-contained material 101 and ignitor 104 is optional. The protective layer(s) may be arranged parallel to the self-contained material 101, and/or compartment 102. One or more protective layers 103 may be arranged to form any suitable shape, shape, curve, geometry, etc. and may be placed in any suitable orientation within the walls 111 of the device 100, provided that self-contained layer 101 is at least substantially protected from compartment 102 until at least the ignitor 104 is fired.

At least some of the thermal energy created by the reaction of the heat-generating composition is conveyed or transferred to the protective layer(s) 103. The protective layer(s) 103 at least partially melt, vaporize, disintegrate, or sublimate due to the heat generated by reaction of the heat-generating composition.

Because the protective layer(s) 103 is in a solid physical state prior to initiation of the reaction in the heat-generating composition but at least a portion thereof becomes a liquid or gas during the reaction, the gas-generating composition can, in some embodiments, can be physically separated from the heat-generating composition during manufacture and storage of the device 100 (e.g. to prevent undesired mixing of the two compositions) but allowed to come into direct contact with the heat-generating composition (or slags or reaction products thereof) during and/or after reaction of the heat-generating composition (e.g. to promote complete reaction of the gas-generating composition, or to accelerate the rate of the reaction). In some embodiments, the protective layer(s) 103 may be configured to physically react within a certain quantity of time after the ignitor 104 is fired, such as near immediately. In some embodiments, the protective layer(s) 103 may allow the reaction of the heat-generating composition to proceed substantially to completion before any significant reaction of the gas-generating composition occurs; in this way, gases evolved from the gas generation reaction will not react with metal oxides in the heat-generating composition or compete with the heat-generating composition for reaction with oxygen, thereby preventing quenching of the heat-generating composition and premature termination of the reactions within the device 100. The protective layer(s) 103 can, in some embodiments, undergo an incomplete or partial thermal decomposition or disintegration, i.e. wherein a portion of the protective layer(s) 103 disintegrates due to heat while another portion of the protective layer(s) 103 remain in the solid state; in this way, it may be possible to achieve one or more of the advantages of a protective layer(s) 103, while simultaneously achieving one or more advantages of a non-decomposing or non-disintegrating protective layer (e.g. maintaining reaction products/slags of the heat-generating composition and/or the gas-generating composition in a desired compartment or physical orientation, preventing reaction products/slags of the heat-generating composition from coming in contact with the gas-generating composition or reaction products/slags thereof (or vice versa), providing a selected extent of “burn-through” of the heat-generating composition, etc.).

In some embodiments, the protective layer(s) 103 may be at least partially constructed of a metal alloy having a melting, vaporization, disintegration, and/or sublimation temperature lower than the temperature achieved by the reaction of the heat-generating composition. Non-limiting examples of such metals include iron, aluminum, copper, tin, zinc, and alloys and mixtures of those and other metals. In some embodiments, the protective layer(s) 103 may be constructed principally or entirely of such alloys, while in other embodiments the protective layer(s) 103 may include a significant fraction or portion of one or more materials that have a melting, vaporization, and/or sublimation temperature higher than the temperature achieved by the reaction of the heat-generating composition, to provide a protective layer 103 configured to undergo an incomplete or partial thermal decomposition or disintegration.

In some embodiments, the protective layer(s) 103 may be at least partially constructed of a mixture of polymers, paper materials, or other easily degradable materials. Non-limiting examples of such polymers and plastics include polyethylene (i.e., low density or high density), polypropylene, polystyrene, polytetrafluoroethylene, polyvinyl chloride, polychlorotrifluoroethylene, and the like. In some embodiments, the protective layer(s) may be constructed of paper materials, metals, polymers, or any combination of suitable materials that result in a protective layer with a desired melting point, strength, structural integrity, or a combination thereof. The materials selected to construct the protective layer(s) 103 may be selected from a set of materials compatible (i.e., non-reactive, chemically inert) with the gas-generating composition and heat-generating composition. The materials selected to construct the protective layer(s) may be selected from a set of materials that result in a protective layer with a desired thermal burden required to at least partially remove the protective layer.

In some embodiments, the protective layer(s) 103 may be constructed of multiple layers of two or more different materials. This construction may be particularly advantageous where it is desirable to provide a protective layers 103 that melts, vaporizes, and/or sublimates in a gradual or staged fashion, i.e. where a first layer or portion of the protective layers 103 melts, vaporizes, and/or sublimates at a first temperature and a second layer or portion of the protective layers 103 melts, vaporizes, and/or sublimates at a second, higher temperature during reaction of the heat-generating composition. This construction may also be particularly advantageous where it is desirable to provide one or more protective layers 103 that undergo an incomplete or partial thermal decomposition or disintegration, i.e., where a first layer or portion of the protective layer(s) 103 disintegrates due to heat and a second layer or portion of the protective layer(s) 103 does not disintegrate due to heat.

In some embodiments, the protective layer(s) 103 may be constructed principally of a combination or mixture of at least two different materials, such as a metal alloy. Non-limiting examples of such combinations and mixtures include steel and brass. The combination or mixture may be substantially homogeneous, or may be provided in a spatially varying form, i.e., where certain regions of the protective layer(s) 103 are particularly rich (or poor) in a selected component of the combination or mixture.

In some embodiments, two or more protective layers included in the device 100 may comprise all of the same, some of the same, or none of the same materials. For example, protective layer 103a may comprise one or more polymers and protective layer 103b may comprise a metal alloy, or vice versa. In some embodiments, protective layers 103a and 103b may be different, standalone layers, or may be the same layer wrapped around the self-contained material 101, for example. In some embodiments, the configuration, arrangement, location, and/or composition of protective layers 103a and 103b may be based at least in part on the arrangement of self-contained material 101, and whether bulk-free-flowing thermite is included in compartment 105.

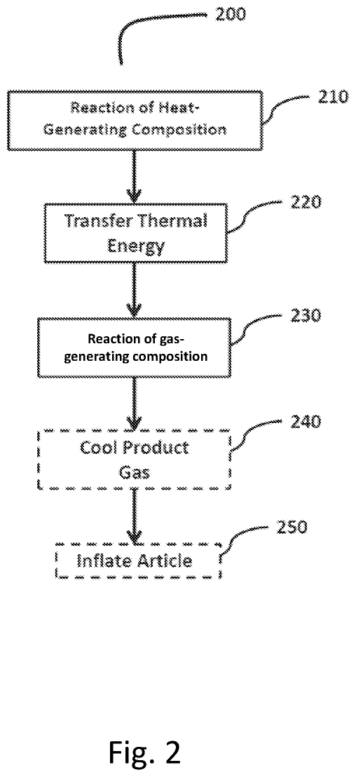

FIG. 2 depicts a process 200 for using the gas generator device 100 of FIG. 1.

In step 210, reaction of a heat-generating composition is initiated in, on, or proximate to a self-contained material 101, in a compartment 105, or both as described with reference to FIG. 1. The reaction releases thermal energy. The heat-generating composition may be a thermite composition comprised of a metal and a metal oxide. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both. The self-contained material 101 may additionally include one or more binding agents, and/or be supported by an internal, physical support.

Step 210 may further include contacting the heat-generating composition with an igniter to initiate the reaction. In some configurations the reaction may be initiated by contacting the igniter with one of a hot wire or a spark. In other configurations, flame may initiate the reaction of the heat-generating composition via the igniter. In yet other configurations, friction may initiate reaction of the heat-generating composition via the igniter. In still other configurations, impact may initiate reaction of the heat-generating composition via the igniter.

In step 220, the energy released by the reaction of the heat-generating composition is transferred from at least the self-contained material 101 to compartment 102. A polymer, metal hydride, and/or oxalate salt is contained in compartment 102. Non-limiting examples of polymer suitable for use include various forms of polyethylene (e.g., low-density polyethylene (LDPE), high-density polyethylene (HDPE), and mixtures thereof), polypropylene, polystyrene, trioxane, polyoxymethylene, and combinations, copolymers, and mixtures thereof. Non-limiting examples of metal hydride suitable for use include lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and combinations and mixtures thereof. Non-limiting examples of oxalate salts suitable for use include tin(II) oxalate (SnC₂O₄), iron(II) oxalate (FeC₂O₄), aluminum oxalate (Al₂(C₂O₄)₃), lithium oxalate (Li₂C₂O₄), sodium oxalate (Na₂C₂O₄), magnesium oxalate (MgC₂O₄), calcium oxalate (CaC₂O₄), ammonium oxalate ((NH₄)₂C₂O₄), other metal oxalates, and combinations and mixtures thereof.

In some implementations, the heat transfer may be direct, such that self-contained material 101 is in direct contact with the polymer, metal hydride, and/or oxalate salt contained in compartment 102. In some implementations, a protective layer 103 as described herein may at least initially exist between the self-contained material 101 and compartment 102. The protective layer 103 may partially or wholly undergo a physical change (e.g., melt, evaporate, disintegrate) in steps 210, 220, 230, or a combination thereof. As such, the self-contained material 101 and the polymer, metal hydride, and/or oxalate salt contained in compartment 102 may at least partially come into direct contact upon physical change of the protective layer 103. Up to and during physical change of the protective layer 103, heat transfer between self-contained material 101 and the polymer, metal hydride, and/or oxalate salt contained in compartment 102 may be indirect via the protective layer 103. During or after the physical change of the protective layer 103, heat transfer between self-contained material 101 and the polymer, metal hydride, and/or oxalate salt contained in compartment 102 may be direct at least in one or more physical locations where protective layer 103 no longer remains between the self-contained material 101 and the polymer, metal hydride, and/or oxalate salt contained in compartment 102.

In step 230, the thermal energy transferred to compartment 102 causes the polymer, metal hydride, and/or oxalate salt to react, e.g., to thermally decompose, to release one or more product gases. Step 230 includes transferring the released thermal energy from the self-contained material 101 to compartment 102, directly or indirectly (via a protective layer). The material and construction of the protective layer 103, and the composition and amount of the polymer, metal hydride, and/or oxalate salt in compartment 102, can be selected to provide for a desired amount or rate of production of the product gas(es). By way of non-limiting example, the protective layer 103 can be constructed such that the gas-generating composition of the self-contained material 101 is physically separated from the heat-generating composition during manufacture and storage of the device 100 (e.g. to prevent undesired mixing of the two compositions) but, as a result of at least a portion of the protective layer 103 physically changing during reaction of the heat-generating composition, the gas-generating composition may be allowed to come into direct contact with the heat-generating composition (or slags or reaction products thereof) during and/or after reaction of the heat-generating composition (e.g. to promote complete reaction of the gas-generating composition, or to accelerate the rate of the reaction).

In optional step 240, the released product gas(es) may be cooled, in some embodiments by a heat exchanger.

In optional step 250, the released gas may be used for one of: inflation of a meteorological balloon; inflation of other types of balloons; inflation of a blimp; inflation of a hypersonic inflatable aerodynamic decelerator (HIAD); inflation of an inflatable article; pressurization of a gas storage cylinder; and the like.

FIG. 3 depicts a non-limiting configuration of a gas generator device 100. The gas generator device 100 comprises a single or common compartment 101 containing both the heat-generating composition and the polymer, metal hydride, and/or oxalate salt, where both the heat-generating composition and the polymer, metal hydride, and/or oxalate salt may be contained in discrete forms. In one non-limiting example, the polymer, metal hydride, and/or oxalate salt may be contained in rods 140, and the heat-generating composition may be contained in self-contained material 145 (i.e., self-contained material 101 as described in the Summary, Detailed Description, and/or with reference to FIGS. 1 and 2) and/or rods 140. In some embodiments, the rods 140 may only comprise polymer, metal hydride, and/or oxalate salt. In some embodiments, a first subset of the rods 140 in device 100 include polymer, metal hydride, and/or oxalate salt and a second subset of the rods 140 in device 100 include heat-generating composition, where the first subset and second subset of rods are different such that polymer, metal hydride, and/or oxalate salt and heat-generating composition are not contained within the same rod 140. The self-contained material 145 may comprise heat-generating composition such as thermite mixture that at least partially remains self-contained, solid, semi-solid, or otherwise minimally interferes with the gas-generating composition before, during, and after the heat-generating reaction and gas-generating reaction. In some embodiments, the self-contained material 145 may include one or more binding agents and/or a support structure to aid in the self-containment of the heat-generating composition.

In some embodiments, device 100 may include one or more protective layers between the polymer, metal hydride, and/or oxalate salt and the heat-generating composition to prevent the polymer, metal hydride, and/or oxalate salt and the heat-generating composition from coming into physical contact during manufacturing, transportation, storage, handling, etc. of the device 100. In one non-limiting example, a protective layer may be arranged vertically between each self-contained material 145 and rod 140 that includes polymer, metal hydride, and/or oxalate salt. In one non-limiting example, a protective layer may not be arranged between a self-contained material 145 and rod 140 that includes additional heat-generating composition. In another non-limiting example, a protective layer may be wrapped, or otherwise arranged wholly around each self-contained material 145.

The compartment 101 is typically separated from an outside environment by a wall 111. Thermal energy generated by reaction of the heat-generating composition can be received by the polymer, metal hydride, and/or oxalate salt, whereby at least some of the thermal energy causes at least some of the polymer, metal hydride, and/or oxalate salt to react, e.g., via thermal decomposition, to release at least one product gas. Transfer of the energy generated by the heat-generating composition to the polymer, metal hydride, and/or oxalate salt may, in some embodiments, be moderated by a protective layer. As will be appreciated, the protective layer can be a continuous or discontinuous layer on the polymer, metal hydride, and/or oxalate salt, the heat-generating composition, or both depending on the configuration.

Typically, at least some of the thermal energy available to the polymer, metal hydride, and/or oxalate salt due to the reaction of the heat-generating composition in the self-contained material 145 and/or rods 140 causes some of the polymer, metal hydride, and/or oxalate salt contained in the rods 140 to undergo a gas generation reaction; in some embodiments, the gas generation reaction may be a thermal decomposition reaction. The gas generation reaction releases one or more product gases. By way of non-limiting example, polyethylene can be thermally decomposed to ethylene gas, and in some embodiments at least a portion of the ethylene gas may be secondarily decomposed (either thermally or catalytically) to hydrogen gas.

In some embodiments, at least about 99 mole % of the polymer, metal hydride, and/or oxalate salt may be converted to the one or more product gases. More generally, at least 95 mole %, even more generally at least about 90 mole %, yet even more generally at least about 80 mole %, still yet even more generally at least about 70 mole %, still yet even more generally at least about 60 mole %, still yet even more generally at least about 50 mole %, still yet even more generally at least about 40 mole %, still yet even more generally at least about 30 mole %, still yet even more generally at least about 20 mole %, or yet still even more generally at least about 10 mole % of the polymer, metal hydride, and/or oxalate salt may be converted to the one or more product gases.

It can be appreciated that, in many embodiments, there is no need to control one or both of the temperature and the rate of thermal energy transfer within the device 100. Moreover, the device 100 can be more easily constructed and operated than other gas generators; for example, the absence of a second compartment may simplify the design of the device 100 and be suitable for applications in which transfer of substantially all of the thermal energy generated by reaction of the heat-generating composition to the polymer, metal hydride, and/or oxalate salt is desirable. Even more advantageously, in those embodiments where control over one or both of the temperature or the rate of energy transfer within the device 100 is required or desired, such control can be achieved by varying the chemical makeup of the thermite or other heat-generating composition within the compartment 101, and/or the spatial arrangement of the polymer, metal hydride, and/or oxalate salt relative to the heat-generating composition in the compartment 101, without the need to redesign the device 100 itself.

The gas generator device 100 may further include an igniter 104 interconnected with the compartment 101. The igniter 104 causes the ignition of the heat-generating composition. In some configurations, a spark generated within the igniter 104 initiates the ignition process. In other configurations, the ignition process is initiated by thermal energy generated within the igniter 104. The thermal energy provided within igniter 104 may be from a hot wire. In other configurations, the initiating energy within igniter 104 may be from flame. In other configurations, the initiating energy within the igniter 104 may be provided by friction and/or impact.

The igniter 104 may further comprise an ignition aperture in the compartment 101. The ignition aperture may be configured with a safety-delay switch system.

The gas generator device 100 may further include a heat exchanger 106 interconnected with the compartment 101. The heat exchanger 106 is configured to cool the product gas(es) released from the polymer, metal hydride, and/or oxalate salt. In accordance with some embodiments, the heat exchanger 106 may be interconnected to outlet 107a of the compartment 101. The exchanger 106 cools the product gas(es) exiting the compartment 101 through outlet 107a, with the cooled gas exiting the exchanger 106 via outlet 107b.

At least some of the thermal energy created by the reaction of the heat-generating composition is conveyed or transferred to one or more protective layers in the device 100. The protective layer(s) at least partially melt, vaporize, disintegrate, or sublimate due to the heat generated by reaction of the heat-generating composition.

Because the protective layer(s) are in a solid physical state prior to initiation of the reaction in the heat-generating composition but at least a portion thereof physically changes, the gas-generating composition can, in some embodiments, be physically separated from the heat-generating composition during manufacture and storage of the device 100 (e.g. to prevent undesired mixing of the two compositions) but allowed to come into direct contact with the heat-generating composition (or slags or reaction products thereof) during and/or after reaction of the heat-generating composition (e.g. to promote complete reaction of the gas-generating composition, or to accelerate the rate of the reaction). In some embodiments, the protective layers(s) and/or due to the self-contained nature of material 145, the reaction of the heat-generating composition may proceed substantially to completion before any significant reaction of the gas-generating composition occurs; in this way, gases evolved from the gas generation reaction will not react with metal oxides in the heat-generating composition or compete with the heat-generating composition for reaction with oxygen, thereby preventing quenching of the heat-generating composition and premature termination of the reactions within the device 100. The protective layer(s) can, in some embodiments, undergo an incomplete or partial thermal decomposition or disintegration, i.e. wherein a portion of the protective layer(s) disintegrates due to heat while another portion of the protective layer(s) remain in the solid state; in this way, it may be possible to achieve one or more of the advantages of a protective layer(s) described herein, while simultaneously achieving one or more advantages of a non-decomposing or non-disintegrating protective layer (e.g. preventing reaction products/slags of the heat-generating composition from coming in contact with the gas-generating composition or reaction products/slags thereof (or vice versa), providing a selected extent of “burn-through” of the heat-generating composition, etc.).

In some embodiments, the protective layer(s) may be at least partially constructed of one or more materials resulting in a melting, vaporization, disintegration, and/or sublimation temperature of the protective layer(s) lower than the temperature achieved by the reaction of the heat-generating composition. In other embodiments the protective layer(s) may include a significant fraction or portion of one or more materials that have a melting, vaporization, and/or sublimation temperature higher than the temperature achieved by the reaction of the heat-generating composition, to provide protective layer(s) configured to undergo an incomplete or partial thermal decomposition or disintegration. The combination or mixture of materials that make up the protective layer(s) may be substantially homogeneous, or may be provided in a spatially varying form, i.e., where certain regions of the protective layer(s) are particularly rich (or poor) in a selected component of the combination or mixture.

In some embodiments, the protective layers(s) may be configured to completely or partially physically change immediately, or near immediately upon ignition of the heat-generating composition. In some embodiments, the protective layers(s) may be configured to completely or partially physically change once a predetermined interval of time has elapsed since ignition of the heat-generating composition. In some embodiments, the protective layers(s) may be configured to completely or partially physically change in accordance with a particular rate.

Each of the protective layers included in device 100 may comprise the same, similar, or different compositions, characteristics (e.g., thickness, melting point, strength), etc. from one another. The composition, characteristics, etc. of each protective layer may be based on the location of the protective layer within the device 100, whether the protective layer is in contact with the heat-generating composition, gas-generating composition, or both, whether the material on either side of the protective layer is free flowing or contained (i.e., self-contained material 145), a desired reaction rate, a desired rate of physical change of the protective layer, an amount of material on either side of the protective layer, or a combination thereof.

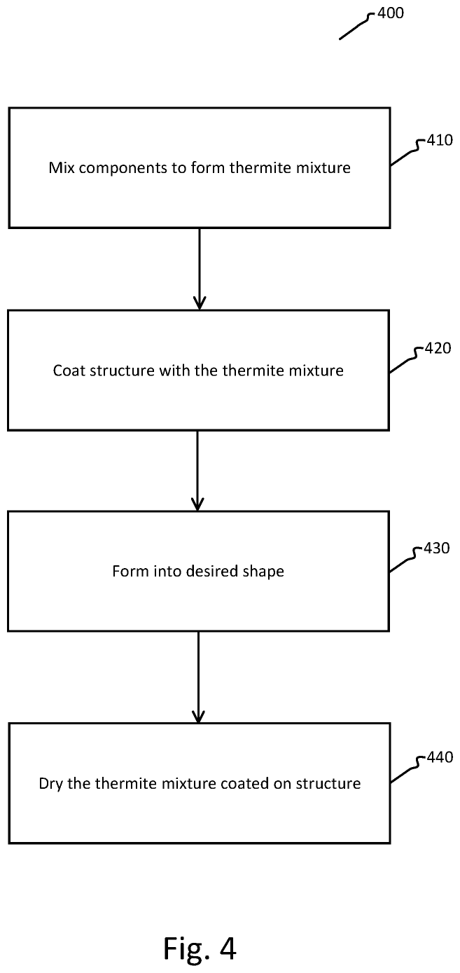

FIG. 4 depicts a process 400 for manufacturing the self-contained thermite material of FIGS. 1 through 3. Alternative examples of the following may be implemented, where some steps are performed in a different order than described or are not performed at all. In some cases, steps may include additional features not mentioned below, or further steps may be added.

In step 410, one or more components are contacted and mixed to for a thermite mixture capable of being self-contained. The one or more components may include a metal, a metal oxide, and in some embodiments, one or more binding agents. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both. The one or more binding agents may be selected from a group of suitable binders which may include organic binders, such as nitrated organic binders.

In some implementations, one or more solvents may be added to the thermite mixture to facilitate thorough mixing and coating of a structure. Suitable solvents include, but are not necessarily limited to, water or xylene, depending on the binder, and the quantity of solvent may be no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, or no more than about 5 wt % of the total composition.

Step 420 may include coating a physical structure (i.e., a support) with the thermite mixture of step 410. The structure may be solid material without gaps (i.e., holes, spaces, non-perforated) or alternatively, may comprise one or more gaps (i.e., perforated, with holes or spaces). In one non-limiting example, the structure may be a mesh, or some other interleaved material made of a network of wire, for example. In the example of a mesh-type support, the mesh may have any number of holes, arranged in a uniform pattern or non-uniform pattern, of any shape and size, etc. The structure may comprise one or more metals (e.g., steel), ceramics, or any other material that will be non-reactive (e.g., chemically and/or physically inert) and/or resistant to reaction with either or both of the heat-generating composition and the gas-generating composition during the gas-generating reaction. Stated another way, the structure may comprise one or more suitable materials that will remain substantially chemically and/or physically unchanged throughout the heat-generating and gas-generating reactions. The structure may be a flat (i.e., smooth) or may comprise any number of indents, grooves, etc. The structure may be a sheet or may be formed into any other shape including but not limited to a coil, block, sphere, wave, etc.

The thermite mixture may be poured over the structure, or the structure may be lowered into and subsequently pulled out of (i.e., dipped into) the thermite mixture, or both. The mixture may be added to the structure by any other suitable means that allows the thermite mixture to sufficiently coat the structure.

In some embodiments, at step 430, the structure coated with the thermite mixture may be shaped into a desired form while the thermite mixture is a desired wetness, or while the structure is considered shapeable (i.e., capable of being shaped).

In step 440, the structure coated with thermite mixture may optionally be allowed to dry. In some embodiments, the thermite composition is heated in a furnace, kiln, or similar device, but it is to be expressly understood that any heating means or mechanism may be used to heat the thermite composition within the scope of the present disclosure. In some embodiments, the thermite composition may be allowed to air-dry at or near room temperature. The structure may be allowed to dry until a certain hardness is reached, until a certain percentage of moisture is removed, etc.

In some embodiments, steps 410, 420, 430, and/or 440 may be repeated as many times as necessary in any order to achieve a self-contained thermite structure with a desired thickness, shape, etc. Upon achieving a self-contained thermite structure with desired characteristics, the self-contained thermite structure may be arranged in a gas generator device 100 as described with reference to FIGS. 1 through 3.

The process described with reference to FIG. 4 may result in a self-contained thermite material formed with a structure or support that at least partially or wholly remains solid, or near solid, and remains self-contained (i.e., the thermite material does not drip, melt, or otherwise interfere with the gas-generating composition) throughout a heat-generating reaction and gas-generating reaction.

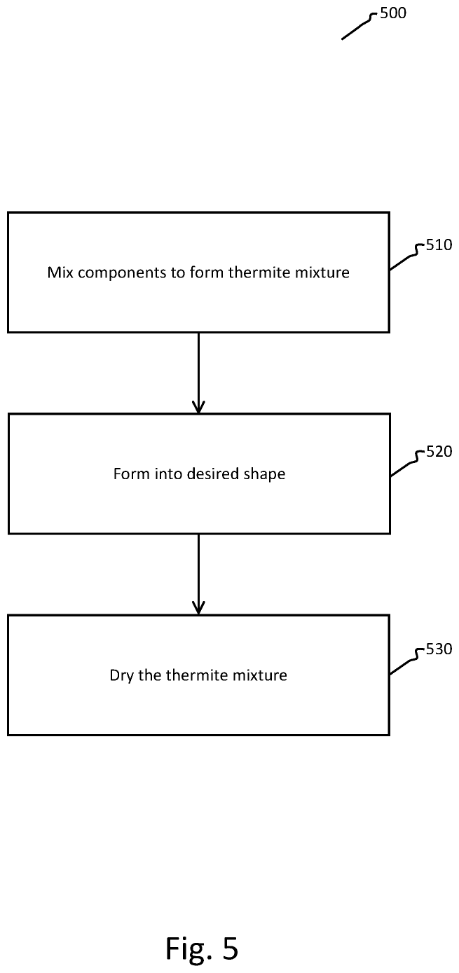

FIG. 5 depicts a process 500 for manufacturing the self-contained thermite material of FIGS. 1 through 3. Alternative examples of the following may be implemented, where some steps are performed in a different order than described or are not performed at all. In some cases, steps may include additional features not mentioned below, or further steps may be added.

In step 510, one or more components are contacted and mixed to for a thermite mixture capable of being self-contained. The one or more components may include a metal, a metal oxide, and in some embodiments, one or more binding agents. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both. The one or more binding agents may be selected from a group of suitable binders which may include organic binders, such as nitrated organic binders.

In some implementations, one or more solvents may be added to the thermite mixture to facilitate thorough mixing and maneuverability of the mixture. Suitable solvents include, but are not necessarily limited to, water or xylene, depending on the binder, and the quantity of solvent may be no more than about 50 wt %, no more than about 45 wt %, no more than about 40 wt %, no more than about 35 wt %, no more than about 30 wt %, no more than about 25 wt %, no more than about 20 wt %, no more than about 15 wt %, no more than about 10 wt %, or no more than about 5 wt % of the total composition.

At 520, the thermite composition may be shaped, cast, molded, or pressed into the desired shape by any suitable known method, including but not limited to slip casting, extrusion, tape casting, pressing, injection molding, plastic forming, and additive manufacturing.

Once the thermite composition has been shaped, cast, molded, or pressed into the desired form, it is optionally dried (e.g., to remove at least a portion of the solvent, if provided), in step 530. In some embodiments, the thermite composition is heated in a furnace, kiln, or similar device, but it is to be expressly understood that any heating means or mechanism may be used to heat the thermite composition within the scope of the present disclosure. In some embodiments, the thermite composition may be allowed to air-dry at or near room temperature. The structure may be allowed to dry until a certain hardness is reached, until a certain percentage of moisture is removed, etc.

In some embodiments, steps 510, 520, and/or 530 may be repeated as many times as necessary in any order to achieve a self-contained thermite structure with a desired thickness, shape, etc. Upon achieving a self-contained thermite structure with desired characteristics, the self-contained thermite structure may be arranged in a gas generator device 100 as described with reference to FIGS. 1 through 3.

The process described with reference to FIG. 5 may result in a self-contained thermite material formed without a structure or support that at least partially or wholly remains solid, or near solid, and remains self-contained (i.e., the thermite material does not drip, melt, or otherwise interfere with the gas-generating composition) throughout a heat-generating reaction and gas-generating reaction.

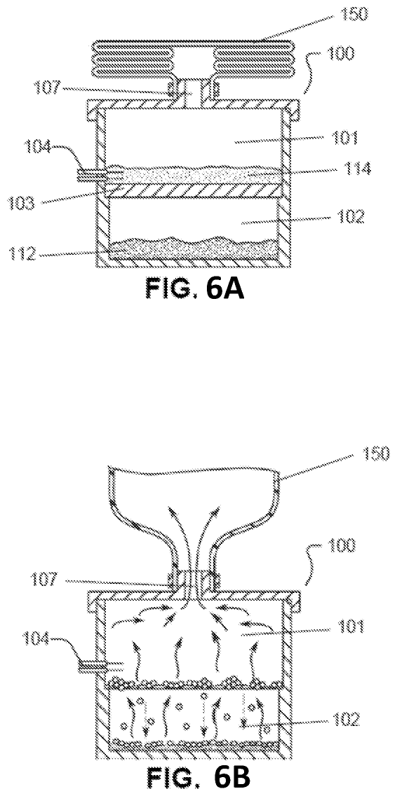

Referring now to FIGS. 6A and 6B, a non-limiting configuration of a gas generator device 100 is illustrated. The container may include an upper compartment 101 and a lower compartment 102, a self-contained heat-generating material 103, and in some cases, one or more protective layers (not depicted). In some embodiments, there may be more than one upper compartment 101 and/or more than one lower compartment 102. It is to be expressly understood that the upper 101 and lower 102 compartments, may, but need not, be completely isolated or sealed from one another; in some embodiments, there may be one or more gaps, passages, spaces, or voids (e.g. about a circumferential edge of the self-contained heat-generating material 103) that allow gases or other materials to pass from the lower compartment 102, adjacent to a first face, side, or surface of the self-contained heat-generating material 103, to the upper compartment 101, adjacent to a second face, side, or surface of the self-contained heat-generating material 103, or vice versa.

The upper compartment 101 and lower compartment 102 have first and second volumes, respectively. The gas generator device 100 has a device volume. In some configurations the device volume can be the sum of the upper 101 and lower 102 compartment volumes. In some configurations, the device volume can be more than the sum of the upper 101 and lower 102 compartment volumes. Although the upper 101 and lower 102 compartments are, in the embodiment illustrated in FIGS. 6A and 6B, stacked one atop the other, it will be appreciated that the compartments can be stacked in any order, or, in other configurations, the upper 101 and lower 102 compartments can be arranged with one of the compartments partly or completely encased in the other. Other spatial configurations are also possible; by way of non-limiting example, the compartments may lie in a horizontal plane (e.g. the upper compartment 101 may instead be a “left” compartment and the lower compartment 102 may instead be a “right” compartment, or vice versa), or the compartments may have a more complex geometric relationship (e.g. the self-contained heat-generating material 103 may be spiral-shaped, with the upper compartment 101 lying adjacent to an outer surface of the spiral-shaped material 103 and the lower compartment 102 lying adjacent to an inner surface of the spiral-shaped material 103, or vice versa). One or more of the device walls (i.e., walls 111 as described with reference to FIG. 1 that encapsulate the 101 and 102 compartments, and self-contained heat-generating material 103 from the environment) may comprise, separately and independently, one or more of steel, aluminum, and ceramic.

In some embodiments, the upper compartment 101 is configured with one or more vents (not depicted).

In some embodiments, after provision of the container having base wall and side walls, construction of the gas generator device 100 proceeds by placing a gas-generating composition 112, such as any one or more polymers, metal hydrides, and/or oxalate salts capable of reacting, e.g., via thermal decomposition, to produce one or more desired product gases, into the lower compartment 102, which initially may not be physically separated from the upper compartment 101. The gas-generating composition 112 may be in forms such as but not limited to pellets, sheets, tubes, rods, fibers, or custom molded shapes.

Optionally, a protective layer (not depicted) may then be placed over the gas-generating composition 112 to hold the gas-generating composition 112 in place in the lower compartment 102; the protective layer, if provided, may be in direct physical contact with the gas-generating composition 112, or there may be a gap or headspace between the gas-generating composition 112 and the protective layer. In some embodiments, the protective layer may be a relatively thin and/or flexible component, and/or may be constructed of material(s) having a relatively low melting, vaporization, and/or sublimation temperature, such that the protective layer melts, vaporizes, sublimates, or otherwise disintegrates during operation of the gas generator device 100; examples of suitable materials for a sealing element 113 of this type is aluminum foil, plastic wrap, paper, etc.

After placement of the gas-generating composition 112 (or, optionally, the protective layer) into the lower compartment 102, construction of the gas generator device 100 proceeds by placing a self-contained heat-generating material 103 into the container that may physically separate the upper compartment 101 and the lower chamber lower chamber 102. The self-contained heat-generating material 103 is in thermal contact with the upper 101 and lower 102 compartments. In this way, thermal energy generated in the upper compartment 101 and/or the self-contained heat-generating material 103 can be transferred to the lower compartment 102 by the self-contained heat-generating material 103, whereby at least some of the thermal energy transferred to the lower compartment 102 causes at least some of the gas-generating composition 112 to undergo a gas generation reaction, which may in some embodiments be a thermal decomposition reaction.

In some embodiments, the self-contained heat-generating material 103 may comprise a mixture of a metal oxide and a metal. The metal oxide may, but need not, be selected from the group consisting of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations thereof, and the metal may, but need not, be selected from the group consisting of aluminum, magnesium, silicon, manganese, an alloy of magnesium and aluminum, and combinations thereof. The thermite composition may, but need not, comprise more than one metal, more than one metal oxide, or both. The self-contained heat-generating material 103 may additionally include one or more binding agents, solvents, and/or an internal support element. The internal support element may be a scaffold (e.g., mesh) or substrate onto which the heat-generating composition is cast, bonded, or cemented prior to being placed in the container.

It is to be expressly understood that after placement of the self-contained heat-generating material 103, the upper 101 and lower 102 compartments, may, but need not, be completely isolated or sealed from one another; in some embodiments, there may be one or more gaps, passages, spaces, or voids (e.g. about a circumferential edge of the self-contained heat-generating material 103) that allow gases or other materials to pass from the lower compartment 102, adjacent to a first face, side, or surface of the self-contained heat-generating material 103, to the upper compartment 101, adjacent to a second face, side, or surface of the self-contained heat-generating material 103, or vice versa. By way of non-limiting example, side walls 111 may be curved such that the container forming the body of the gas generator device 100 is cylindrical or approximately cylindrical, and the self-contained heat-generating material 103 may be a disk having a diameter smaller than an interior diameter of the cylindrical container and supported by any suitable means (e.g. resting on catches or stops provided for that purpose inside the gas generator device 100, or directly on top of the gas-generating composition 112 or protective layer), such that product gas(es) formed by reaction of the gas-generating composition 112, or other materials, can pass from the lower compartment 102 to the upper compartment 101 (or vice versa) via an annular space between the circumferential edge of the self-contained heat-generating material 103 and side walls.

After placement of the self-contained heat-generating material 103 into the container to define and separate the upper 101 and lower 102 compartments, construction of the gas generator device 100 proceeds by optionally placing a heat-generating composition 114, such as a thermite composition, into the upper compartment 102. Where the heat-generating composition 114 is a thermite composition, a metal oxide of the thermite composition may, but need not, be selected from the group consisting essentially of vanadium (V) oxide, iron (III) oxide, iron (II,III) oxide, copper (II) oxide, copper (I) oxide, tin (IV) oxide, titanium dioxide, manganese dioxide, manganese (III) oxide, chromium (III) oxide, cobalt (II) oxide, silicon dioxide, nickel (II) oxide, silver oxide, molybdenum trioxide, lead (II,IV) oxide, bismuth (III) oxide, and combinations and mixtures thereof, and a metal of the thermite composition may, but need not, be selected from the group consisting of aluminum, magnesium, silicon, manganese, an alloy of magnesium and aluminum, and combinations and mixtures thereof. The thermite composition may, but need not, comprise more than one metal, more than one metal oxide, or both. In one configuration, the heat-generating composition 114 comprises a thermite composition that comprises a mixture of ferric oxide and aluminum. It is typical, especially when the heat-generating composition 114 is a thermite composition, to provide the heat-generating composition 114 either in the form of a powder or mixture of powders, or as a cast, bonded, or cemented sheet or other article, but it is to be appreciated that the heat-generating composition 114 can take any of a number of other suitable physical forms, including, by way of non-limiting example, pellets, sheets, tubes, rods, and fibers. The heat-generating composition 114 may be different from the composition of the self-contained heat-generating material 103. In one-non-limiting example, the heat-generating composition 114 may not include binding agents or solvents.

After the optional placement of the heat-generating composition 114 into the upper compartment 101, construction of the gas generator device may further include provision of an igniter 104 and/or a top enclosure comprising an outlet 107. The igniter 104 may cause the ignition of the self-contained heat-generating material 103 and, in some implementations, the heat-generating composition 114; in some configurations, a spark generated within the igniter 104 may initiate the ignition process, while in other configurations, the ignition process may be initiated by thermal energy generated within the igniter 104. The thermal energy provided within igniter 104 may be from a hot wire. In other configurations, the initiating energy within igniter 104 may be from flame. In other configurations, the initiating energy within the igniter 104 may be provided by friction and/or impact. The igniter 104 may further comprise an ignition aperture in the upper compartment 101, which may be configured with a safety-delay switch system. The product gas(es) released from the gas-generating composition 112 may be released through outlet 107; in some embodiments, the outlet 107 may be interconnected with a heat exchanger 106 (not depicted in FIGS. 6A and 6B) that is configured to cool the product gas(es). Optionally, the outlet 107 (and/or heat exchanger 106, if provided) may comprise or be interconnected with one or more filters, sieves, traps, condensers, or other similar components to selectively remove an identified undesirable species from the product gas(es).

The gas generator device 100 is in fluid communication with an inflatable article 150. As shown, operation of the gas generator device 100 causes the product gas(es) to be released through outlet 107 into the inflatable article 150, thereby inflating the inflatable article 150. In some embodiments, the inflatable article 150 may be selected from the group consisting of a balloon (e.g., a meteorological balloon), a blimp, or a HIAD. Although the embodiment of the gas generator device 100 illustrated in FIGS. 6A and 6B is shown in association with an inflatable article 150, which is initially in a collapsed, deflated, or uninflated state (FIG. 6A) and is inflated as a result of operation of the gas generator device 100 (FIG. 6B), it is to be expressly understood that gas generator devices 100 as depicted in FIGS. 6A and 6B may be provided for any suitable purpose and in association with any other suitable apparatuses, devices, and systems for which generation of a gas may be desired.

Prior to ignition of the self-contained heat-generating material 103, and in some implementations, the heat-generating composition 114 (FIG. 6A), the self-contained heat-generating material 103 is entirely in the solid state and acts as a rigid barrier between the upper 101 and lower 102 compartments, and therefore between the optional heat-generating 114 and gas-generating 112 compositions. In some embodiments, the self-contained heat-generating material 103 may be at least partially surrounded on one or more sides by one or more protective layers that additionally act as a barrier between the heat-generating composition (within the self-contained heat-generating material 103 and heat-generating composition 114) and gas-generating 112 composition.

It is to be expressly understood, however, that the upper 101 and lower 102 compartments, may, but need not, be completely isolated or sealed from one another, and that in some embodiments, there may be one or more gaps, passages, spaces, or voids (e.g. about a circumferential edge of the self-contained heat-generating material 103) that allow gases or other materials to pass from the lower compartment 102, adjacent to a first face, side, or surface of the self-contained heat-generating material 103, to the upper compartment 101, adjacent to a second face, side, or surface of the self-contained heat-generating material 103, or vice versa.

In operation, when generation of one or more product gas(es) is desired, the heat-generating composition 114 is ignited, in some embodiments by an igniter 104 in association with the upper compartment 101 (FIG. 7B).

After ignition, the heat-generating composition (within the self-contained heat-generating material 103 and optionally, the heat-generating composition 114) begins to react and form reaction products and/or slags 116, and the heat generated by the reaction of the heat-generating composition 114 causes at least a portion of the protective layers to melt, vaporize, sublimate, or otherwise disintegrate.

As reaction of the heat-generating composition continues (within the self-contained heat-generating material 103 and optionally, the heat-generating composition 114), heat is transferred from the upper compartment 101 to the lower compartment 102 to initiate reaction of the gas-generating composition 112. As a result, the reacted slag of the self-contained heat-generating material 103 may remain solid or semi-solid and remain in the self-contained location such that the reacted slag does not drip or melt into the gas-generating composition 112. Similarly, if other heat-generating composition 114 is present, it will sit atop of the self-contained material 103 upon reaction.

As the gas-generating composition 112 reacts (e.g., a polymer, metal hydride, and/or oxalate salt in the lower compartment 102 decomposes), the product gas(es) evolved by this reaction flow from the lower compartment 102 into the upper compartment 101 (e.g. by diffusion through the self-contained material 103; by passage through holes or voids in the self-contained material 103, whether pre-fabricated or as a result of melting, sublimation, or vaporization of portions of the self-contained material 103; via an annular space between a circumferential edge of the self-contained material 103 and side walls of the gas generator device 100; by use of a port, vent, or pump; etc.), and then through outlet 107 and into the inflatable article 150 to inflate the inflatable article 150.

Embodiments of the devices and methods disclosed herein may be directed to the thermal decomposition of any one or more polymers, such as polyethylene, polypropylene, polystyrene, trioxane, polyoxymethylene, and combinations, copolymers, and mixtures thereof. Additionally or alternatively, embodiments of the devices and methods disclosed herein may be directed to the thermal decomposition of any one or more metal hydrides, such as lithium aluminum hydride (LiAlH₄), sodium aluminum hydride (NaAlH₄), potassium aluminum hydride (KAlH₄), lithium borohydride (LiBH₄), sodium borohydride (NaBH₄), potassium borohydride (KBH₄), lithium hydride (LiH), sodium hydride (NaH), potassium hydride (KH), magnesium hydride (MgH₂), calcium hydride (CaH₂), and combinations and mixtures thereof. Additionally or alternatively, embodiments of the devices and methods disclosed herein may be directed to the thermal decomposition of any one or more oxalate salts, such as tin(II) oxalate (SnC₂O₄), iron(II) oxalate (FeC₂O₄), aluminum oxalate (Al₂(C₂O₄)₃), lithium oxalate (Li₂C₂O₄), sodium oxalate (Na₂C₂O₄), magnesium oxalate (MgC₂O₄), calcium oxalate (CaC₂O₄), ammonium oxalate ((NH₄)₂C₂O₄), other metal oxalates, and combinations and mixtures thereof.

Embodiments of the devices and methods disclosed herein may be directed to the production of any one or more product gases, but particularly may be directed to the production of ethylene gas, and/or (either directly or by secondary thermal or catalytic decomposition of ethylene) hydrogen gas. Ethylene gas, or hydrogen gas, or the combination of ethylene and hydrogen gases may, in embodiments, generally make up at least about 75 mol %, more generally at least about 70 mol %, even more generally at least about 65 mol %, yet even more generally at least about 60 mol %, still yet even more generally at least about 55 mol %, still yet even more generally at least about 50 mol %, still yet even more generally at least about 45 mol %, still yet even more generally at least about 40 mol %, still yet even more generally at least about 35 mol %, still yet even more generally at least about 30 mol %, or still yet even more generally at least about 25 mol % of the total product gas content.

In embodiments of the devices and methods disclosed herein, the composition of the product gas(es) may be such that it is not necessary to provide additional heat or other (or, in some cases, any) energy inputs to maintain most or all of the product gas(es) in the desired gaseous state after formation of the gas. By way of non-limiting example, the product gas(es) may in some embodiments be passively or actively cooled to ambient or near-ambient temperatures (e.g., at least substantially, if not entirely, free of added heat or thermal energy relative to ambient conditions), without risk of undesirable condensation of product gas(es). In this way, the devices and methods disclosed herein may advantageously serve differing purposes relative to gas generation devices and methods of the prior art.

In some embodiments, the precise chemical composition or properties of the one or more product gas(es) are not a consideration, or at least are not as crucial a consideration, as the rate or amounts (whether molar or mass amounts) in which the product gas(es) can be generated; by way of non-limiting example, it may be desirable to produce as great a molar quantity of gas as possible to inflate an inflatable article to the greatest extent possible, since volume is directly related not to mass of the gas but to its molar quantity. In these applications, it may be desirable to cause the polymer, metal hydride, and/or oxalate salt to react in the first instance, and/or to cause one or more product gas(es) to undergo secondary reaction, into as “small” (in molecular weight terms) a gas as possible to increase the volume of gas produced without requiring additional mass of materials. One such desirable “small” gas is hydrogen gas (H₂). Thus, in embodiments, a heat-generating composition may be provided that provides temperatures great enough to rapidly facilitate decomposition of, e.g., ethylene gas (produced, e.g., by decomposition of polyethylene) to hydrogen gas. In other embodiments, a catalyst may be provided in the compartment containing the polymer, metal hydride, and/or oxalate salt that catalyzes the decomposition of a product gas into hydrogen gas or another “small” gas.

In some embodiments, it may be necessary to minimize or eliminate byproducts, impurities, and other undesirable species in the product gas(es). However, limitations on the availability of a suitable polymer, metal hydride, and/or oxalate salt may necessitate the use of a polymer, metal hydride, and/or oxalate salt that is susceptible to the production of such byproducts, impurities, and undesirable species. By way of non-limiting example, higher hydrocarbons such as C4 hydrocarbons may be produced when decomposing polymers such as polyethylene, polypropylene, polystyrene, trioxane, or polyoxymethylene, which could be undesirable due to condensation in low-temperature applications. Thus, devices and systems of the present disclosure may include one or more filters, sieves, traps, condensers, or other similar components to selectively remove an identified undesirable species from the product gas(es). Such components can be provided in association with the compartment in which the product gas(es) is/are formed by decomposition of the polymer, metal hydride, and/or oxalate salt, or they can be provided in association with a separate compartment into which the one or more product gases flow after formation.

In some embodiments, it may be desirable to provide for further chemical processing of the one or more product gases. Particularly, it may be desirable to provide for subsequent chemical reaction of one or more product gases, e.g., gas production or gas reformation. In such embodiments, the devices and methods of the invention may employ a catalyst configured to facilitate such chemical processing of the one or more product gases. Such catalyst may be provided in any desired spatial arrangement (e.g., a fixed bed), and may be present either in the compartment in which the one or more product gases are formed (i.e., the compartment containing the polymer, metal hydride, and/or oxalate salt), or in a separate compartment configured to receive the one or more product gases.

In embodiments of the present disclosure, the gas-generating composition, i.e., the polymer, metal hydride, and/or oxalate salt, may be selected based on the identity of the gas or gases desired to be produced. By way of non-limiting example, where a gas desired to be produced is ethylene gas, polyethylene may be selected as the gas-generating composition. In some embodiments, the desired gas may be a secondary decomposition product, i.e. a gas that is produced by first thermally decomposing the gas-generating composition into an intermediate species and then further thermally or catalytically decomposing the intermediate species to the desired gas, and the gas-generating composition may be selected accordingly; by way of non-limiting example, where a desired gas is hydrogen gas, polyethylene may be selected as the gas-generating composition, and the gas generator device 100 may be configured to first decompose the polyethylene to ethylene gas and subsequently (due to, e.g., increased temperature or the presence of a catalyst) decompose the ethylene gas to hydrogen gas. Other polymers suitable for producing these or other product gases include polypropylene, polystyrene, trioxane, and polyoxymethylene.

In embodiments of the present disclosure, the gas-generating composition, e.g., polymer, metal hydride, and/or oxalate salt, may be provided in any suitable physical form. By way of first non-limiting example, the gas-generating composition may be provided in a physical form comprising one or more pellets. By way of second non-limiting example, the gas-generating composition may be provided in a physical form comprising one or more sheets. By way of third non-limiting example, the gas-generating composition may be provided in a physical form comprising one or more tubes. By way of fourth non-limiting example, the gas-generating composition may be provided in a physical form comprising one or more rods. By way of fifth non-limiting example, the gas-generating composition may be provided in a physical form comprising one or more fibers. By way of sixth non-limiting example, the gas-generating composition may be provided in a physical form comprising one or more molded shapes or articles.

While the foregoing disclosure has in some cases focused on the production of gases in the context of inflating an inflatable article, it is to be expressly understood that the devices and methods of the disclosure are suitable to produce one or more product gases for any desired application. By way of first non-limiting example, the devices and methods of the disclosure may be used to fill or pressurize a cylinder, tank, or vessel, e.g., a storage cylinder or tank, with a desired gas. By way of second non-limiting example, the devices and methods of the disclosure may be used to produce a lifting gas to be used in, e.g., a buoyant vehicle or article such as a hot air balloon or a float. By way of third non-limiting example, the devices and methods of the disclosure may be used to produce a selected atmosphere within a volume, e.g., ethylene gas may be produced and used in a “ripening room” to accelerate the ripening of fruits and vegetables. These and other applications are within the scope of the present disclosure.

Several variations and modifications of the disclosure can be used. It would be possible to provide for some features of the disclosure without providing others.

The present disclosure, in various aspects, embodiments, and configurations, includes components, methods, processes, systems and/or apparatus substantially as depicted and described herein, including various aspects, embodiments, configurations, sub-combinations, and subsets thereof. Those of skill in the art will understand how to make and use the various aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and/or reducing cost of implementation.

The disclosure illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure, which is limited only by the claims which follow.

The foregoing discussion of the disclosure has been presented for purposes of illustration and description. The foregoing is not intended to limit the disclosure to the form or forms disclosed herein. In the foregoing Detailed Description, for example, various features of the disclosure are grouped together in one or more embodiments for the purpose of streamlining the disclosure. The features of the embodiments of the disclosure may be combined in alternate embodiments other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the description of the disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

1. A device, comprising:
at least one self-contained article comprising a pyrotechnic composition; and
at least one gas generating composition, proximate to a first surface of the self-contained article.

2. The device of claim 1, wherein the pyrotechnic composition byproducts remain substantially in the same location by virtue of their viscosity or solid nature during a gas generation reaction of the at least one gas generating composition.

3. The device of claim 1, wherein the at least one self-contained article further comprises a structure, wherein the structure physically supports the pyrotechnic composition.

4. The device of claim 3, wherein the structure comprises a supporting mesh.

5. The device of claim 1, wherein the at least one self-contained article further comprises one or more binding agents.

6. The device of claim 1, further comprising at least one protective layer, wherein the at least one protective layer prevents physical contact between the pyrotechnic composition and the at least one gas generating composition.

7. The device of claim 6, wherein at least a portion of the at least one protective layer is configured to undergo thermal decomposition, using heat generated by a reaction of the pyrotechnic composition.

8. The device of claim 7, wherein the at least one protective layer is configured such that an unimpeded path exists between at least a portion of the pyrotechnic composition, or reaction products thereof, and at least a portion of the at least one gas generating composition following the thermal decomposition.

9. The device of claim 3, wherein the structure is configured to physically support at least a portion of reaction products of a reaction of the pyrotechnic composition.

10. The device of claim 6, wherein the at least one protective layer comprises a metal, polymer, paper, or a combination thereof.

11. The device of claim 1, wherein the pyrotechnic composition is a thermite composition comprising a mixture of a metal fuel and a metal oxide oxidizer that undergoes an exothermic reduction-oxidation reaction when ignited by heat.

12. The device of claim 1, wherein the at least one gas generating composition comprises a metal hydride.

13. The device of claim 1, wherein the at least one gas generating composition comprises an oxalate salt.

14. The device of claim 1, wherein the at least one gas generating composition comprises a polymer.

15. The device of claim 1, wherein the at least one self-contained article comprises two or more self-contained articles, or the at least one gas generating composition comprises two or more gas generating compositions, or both.

16. The device of claim 15, wherein the at least one self-contained article comprises two or more self-contained articles and the at least one gas generating composition comprises two or more gas generating compositions, and wherein the two or more self-contained articles and the two or more gas generating compositions are disposed in a multi-layer configuration in which successive layers alternate between self-contained articles and gas generating compositions.

17. A method for generating at least one gas, comprising:
initiating reaction of a pyrotechnic composition, comprising a metal oxide and a metal and provided as part of a self-contained article, to release thermal energy; and
causing, using the thermal energy released by the reaction, at least some of one or more gas generating compositions to undergo a reaction to release the at least one gas.

18. The method of claim 17, wherein the pyrotechnic composition byproducts remain substantially in the same location by virtue of their viscosity or solid nature during the gas generation reaction step.

19. The method of claim 17, wherein the self-contained article further comprises a structure, wherein the structure physically supports the pyrotechnic composition.

20. The method of claim 19, wherein at least a portion of reaction products of the reaction of the pyrotechnic composition are physically supported by the structure.

21. The method of claim 19, wherein the structure comprises a mesh.

22. The method of claim 17, wherein the self-contained article further comprises one or more binding agents.

23. The method of claim 17, wherein at least one protective layer prevents physical contact between the pyrotechnic composition and the gas generating composition.

24. The method of claim 23, further comprising causing at least a portion of at least one protective layer to undergo thermal decomposition using the thermal energy released by the reaction of the pyrotechnic composition.

25. The method of claim 24, wherein the at least one protective layer is configured such that an unimpeded path exists between at least a portion of the pyrotechnic composition, or reaction products thereof, and at least a portion of the gas generating composition following the decomposing step.

26. The method of claim 17, wherein the gas generating composition comprises a metal hydride.

27. The method of claim 17, wherein the gas generating composition comprises an oxalate salt.

28. The method of claim 17, wherein the gas generating composition comprises a polymer.

29. An inflatable device, comprising:
an inflatable article; and
a gas generator:
a) interconnected to the inflatable article;
b) configured to inflate the inflatable article; and
c) comprising:
i) a thermite composition comprising a metal oxide and a metal; and
ii) at least one gas generating composition,
wherein the gas generator is configured to generate at least one product gas by (i) initiating a reaction of the thermite composition to release thermal energy and (ii) using the thermal energy released by the reaction of the thermite composition to cause a gas generation reaction of the at least one gas generating composition to generate the at least one product gas, and wherein byproducts of the reaction of the thermite composition remain substantially in the same location by virtue of their viscosity or solid nature during the gas generation reaction of the at least one gas generating composition.

30. The inflatable device of claim 29, wherein the gas generator further comprises a self-contained article comprising the thermite composition and one or more binding agents.

31. The inflatable device of claim 29, wherein the gas generator further comprises a self-contained article comprising the thermite composition and a structure that physically supports the thermite composition.

32. The inflatable device of claim 29, wherein the gas generator further comprises at least one protective layer positioned between and in thermal contact with the thermite composition and the at least one gas generating composition, wherein at least a portion of the at least one protective layer is configured to undergo thermal decomposition using heat generated by the reaction of the thermite composition.

33. The inflatable device of claim 32, wherein the at least one protective layer is configured such that an unimpeded path exists between at least a portion of the thermite composition, or reaction products thereof, and at least a portion of the gas generating composition following the gas generation reaction.

34. The inflatable device of claim 29, further comprising an igniter configured to ignite the thermite composition.
